(19) United States
(12) Patent Application Publication
(10) Pub. No.: US 2025/0382547 A1
(43) Pub. Date: Dec. 18, 2025

(54) PARTICULATE LAUNDRY SOFTENING WASH ADDITIVE

(71) Applicant: The Procter & Gamble Company, Cincinnati, OH (US)

(72) Inventors: Lidiany GONZALEZ, West Chester, OH (US); Jocelyn Michelle MCCULLOUGH, Loveland, OH (US); Kristin Rhedrick WILLIAMS, West Chester, OH (US); Carola BARRERA, West Chester, OH (US); Mark Robert SIVIK, Mason, OH (US)

(21) Appl. No.: 18/746,373

(22) Filed: Jun. 18, 2024

(51) Int. Cl. C11D 1/58; C11D 1/835; C11D 3/37; C11D 17/06

(52) U.S. Cl. CPC C11D 1/58; C11D 1/835; C11D 3/3715; C11D 3/373; C11D 17/06; C11D 2111/12

(57) ABSTRACT

A composition including a plurality of particles, the plurality of particles comprising: about 25% to about 93% by weight a water soluble carrier; about 5% to about 45% by weight a first hydrophobic conditioning compound having a weight average molecular weight greater than 1000 Da; about 0.5% to about 10% by weight a cationic polysaccharide; and nonionic surfactant; and wherein individual particles of the plurality of particles have a mass from about 1 mg to about 1 g.

### FIELD OF THE INVENTION

Through the wash laundry softening additive.

### BACKGROUND OF THE INVENTION

Consumers continually express interest in products that can simplify the processes they use to launder clothes, help them reduce the amount of time they spend dealing with dirty laundry, and help them achieve high levels of cleanliness and softness for their family's clothing. Cleaning and softening of laundry presently require consumers to dose two products to either different compartments of the washing machine or to dose one product to the washing machine and one product to the dyer.

The process of laundering fabric can be broken up into three basic steps: washing, rinsing, and drying. The washing step typically employs water and detergent composition comprising anionic surfactant, along with other active agents that are compatible with anionic surfactants in the unused product form and in the wash liquor formed during the washing step. After washing, the laundry is rinsed one or more times as part of the rinsing step.

Presently, laundry softening is most often and practically accomplished during the rinsing step with a liquid softening composition that is separate from the detergent composition or during the drying step. To apply liquid softening composition to the laundry in the washing machine, the liquid softening composition is introduced to the laundry during the rinsing step. The liquid softening composition may be automatically introduced into the rinse from a compartment that keeps the liquid softening composition separate from the washing composition. The compartment may be part of the agitator, if present, or another part of the washing machine that can be opened to dispense the liquid softening composition into the drum. This is often referred to as softening through the rinse. Softening through the rinse requires the consumer to dose the detergent composition and the softening composition to different locations of the washing machine, which is inconvenient.

Laundry softening can also be accomplished during the drying step using fabric softening sheets. With either of these approaches to cleaning and softening, cleaning is performed separately from softening.

Consumers find it inconvenient to have to dispense multiple products to different locations, whether the locations are part of the washing machine or the locations are distributed between the washing machine and the dryer. What the consumer would like is to be able to dose the detergent composition and the softening composition to a single location.

Unfortunately, liquid detergent compositions tend to be incompatible with softening compositions. Liquid detergent compositions comprise anionic surfactants to help clean the clothing. Softening compositions typically comprise cationic surfactants to soften the clothing. When combined in a single package, the anionic surfactant and cationic surfactant can combine and form a solid precipitate. This results in a problem with stability of the combination when packaged together in a liquid form or together in a wash liquor and a decrease in cleaning performance as compared to the detergent composition in absence of the softening composition. This incompatibility problem is among the reasons that detergent compositions and fabric softening compositions are dosed and applied separate from one another. Liquid fabric softening compositions packaged separately from detergent compositions may not be preferred by some consumers due to the inconvenience of dosing the composition to the washing machine, perceived messiness, and the texture of the product.

With these limitations in mind, there is a continuing unaddressed need for a solid form through the wash fabric softening composition that can be dispensed by the consumer together with the laundry detergent to providing softening through the wash during the washing step. Attempts have been made to provide a solid form through the wash fabric softening composition comprising softening agents having a small particle size to avoid undesired staining of the treated surface. Some of these softening actives can crystallize depending on temperature conditions during processing due to their intrinsic chemical nature or residual impurities. Minimizing the degree of crystallization can reduce or prevent agglomeration of the actives during processing, resulting in smaller particle sizes of the softening active within the through the wash fabric softening composition and dispersions thereof, and limit undesired fabric staining.

### SUMMARY OF THE INVENTION

A composition comprising a plurality of particles, the plurality of particles comprising: about 25% to about 93% by weight a water soluble carrier; about 5% to about 45% by weight a first hydrophobic conditioning compound having a weight average molecular weight greater than 1000 Da; about 0.5% to about 10% by weight a cationic polysaccharide; and about 0.5% to about 20% by weight a nonionic surfactant; and wherein individual particles of the plurality of particles have a mass from about 1 mg to about 1 g.

### BRIEF DESCRIPTION OF THE DRAWINGS

FIG. 1 is an apparatus for forming particles.

FIG. 2 presents images of Control A and selected premixes.

FIG. 3 are SAXS scattering patterns of Control A and selected premixes.

### DETAILED DESCRIPTION OF THE INVENTION

The composition described herein can provide for a through the wash fabric softening composition that is convenient for the consumer to dose to the washing machine. The through the wash fabric softening composition can be provided in a composition comprising a plurality of particles. The particles can be provided in a package that is separate from the package of detergent composition. Having the softening composition particles in a package separate from the package of detergent composition can be beneficial since it allows the consumer to select the amount of softening composition independent of the amount of detergent composition used. This can give the consumer the opportunity to customize the amount of softening composition used and thereby the amount of softening benefit they achieve, which is a highly valuable consumer benefit.

Particulate products, especially particulates that are not dusty, are preferred by many consumers. Particulate products can be easily dosed by consumers from a package directly into the washing machine or into a dosing compartment on the washing machine. Or the consumer can dose from the package into a dosing cup that optionally provides one or more dosing indicia and then dose the particulates into a dosing compartment on the washing machine or directly to the drum. For products in which a dosing cup is employed, particulate products tend to be less messy than liquid products.

The plurality of particles of the fabric softening composition can comprise a water soluble carrier and a first hydrophobic conditioning compound having a weight average molecular weight greater than 1000 Da (Da being the abbreviation for Daltons). Optionally, they may comprise a cationic polysaccharide. The carrier carries the first hydrophobic condition compound to the washing machine. The particles are dissolved into the wash liquor. The first hydrophobic conditioning compound is deposited from the wash liquor onto the fibers of the fabric.

### Water Soluble Carrier

The plurality of particles can comprise a water soluble carrier. The plurality of particles can comprise from about 25% to about 94%, optionally from about 25% to about 93%, optionally from about 30% to about 90%, optionally from about 35% to about 88%, optionally from about 40% to about 88%, optionally from about 45% to about 85%, optionally combinations thereof and any whole percentages or ranges of whole percentages within any of the aforementioned ranges, by weight of the plurality of particles. The water soluble carrier acts to carry the fabric care benefit agents to the wash liquor. Upon dissolution of the water soluble carrier, the first hydrophobic conditioning compound and any additional substances constituting the particles are dispersed into the wash liquor.

Water soluble means that the material or particle is soluble or dispersible in water, and optionally has a water-solubility of at least 50%, optionally at least 75% or even at least 95%, as measured by the method set out hereafter using a glass-filter with a maximum pore size of 20 microns: 50 grams±0.1 gram of the carrier is added in a pre-weighed 400 mL beaker and 245 mL±1 mL of distilled water is added. This is stirred vigorously on a magnetic stirrer set at 600 rpm, for 30 minutes. Then, the mixture is filtered through a sintered-glass filter with a pore size as defined above (max. 20 micron). The steps are performed at a temperature of 23° C.±1.0° C. and a relative humidity of 50%±2%. The water is dried off from the collected filtrate by any conventional method, and the weight of the remaining material is determined (which is the dissolved or dispersed fraction). Then, the percentage solubility or dispersibility can be calculated.

The water soluble carrier can be or comprise a material selected from the group of water soluble carbohydrates with less than ten saccharide units including dextrose, fructose, galactose, isoglucose, glucose, sucrose, raffinose, isomalt, xylitol, candy sugar, coarse sugar, corn syrup solids, sucrose, and combinations thereof.

The water soluble carrier can be selected from the group of polysaccharide and modified polysaccharide that are not cationic with more than ten saccharide units including maltodextrin, starch, corn starch, wheat starch, rice starch, potato starch, tapioca starch, carboxymethyl cellulose, cellulose, alkyl cellulosics such as methyl cellulose, ethyl cellulose and propyl cellulose; cellulose ethers; cellulose esters; nonionic or anionic cellulose amides, polysaccharides including starch, modified starch that is not cationic; gelatin; alginates; xyloglucans, other hemicellulosic polysaccharides including xylan, glucuronoxylan, arabinoxylan, mannan, glucomannan and galactoglucomannan; and natural gums such as pectin, xanthan, and carrageenan, locus bean, arabic, tragacanth, alkylhydroxy cellulosics such as methylcellulose, carboxymethylcellulose sodium, modified carboxy-methylcellulose that is not cationic, dextrin, ethylcellulose, propylcellulose, hydroxyethyl cellulose, hydroxypropyl methylcellulose, maltodextrin; hydroxypropyl methyl cellulose (HPMC); cellulose, alkyl cellulosics, methyl cellulose, ethyl cellulose, propyl cellulose, cellulose ethers, cellulose esters, polysaccharides, alkylhydroxy cellulosics, methylcellulose, carboxymethylcellulose sodium, dextran, ethylcellulose, propylcellulose, hydroxyethyl cellulose, hydroxypropyl methylcellulose, hydroxypropyl methyl cellulose, maltodextrin and combinations thereof.

The water soluble carrier can be selected from the group of clay, silicate, citric acid, water soluble silicate, water soluble urea, clay, water insoluble silicate, zeolites silicates, zeolites, polyethylene glycol, and combinations thereof.

The water soluble carrier can be selected from the group of polyethylene glycol, polypropylene glycol polyoxoalkylene, polyethylene glycol fatty acid ester, polyethylene glycol ether, and mixtures thereof.

The water soluble carrier can be a water soluble polymer. The water soluble polymer can be selected from the group of C8-C22 alkyl polyalkoxylate comprising more than about 40 alkoxylate units, ethoxylated nonionic surfactant having a degree of ethoxylation greater than about 30, polyalkylene glycol having a weight average molecular weight from about 2000 to about 15000, and combinations thereof.

The water soluble polymer can be a block copolymer having Formulae (I), (II), (III) or (IV), R¹O-(EO)x-(PO)y-R² (I), R¹O--(PO)x-(EO)y-R²(II), R¹O-(EO)o-(PO)p-(EO)q-R² (III), R¹O--(PO)o-(EO)p-(PO)q-R² (IV), or a combination thereof; wherein EO is a —CH₂CH₂O— group, and PO is a —CH(CH₃)CH₂O— group; R¹ and R² independently is H or a C1-C22 alkyl group; x, y, o, p, and q independently is 1-100; provided that the sum of x and y is greater than 35, and the sum of o, p and q is greater than 35; wherein the block copolymer has a molecular weight ranging from about 3000 Da to about 15000 Da.

The water soluble polymer can be a block copolymer or block copolymers, for example a block copolymer based on ethylene oxide and propylene oxide selected from the group of PLURONIC-F38, PLURONIC-F68, PLURONIC-F77, PLURONIC-F87, PLURONIC-F88, and combinations thereof. PLURONIC materials are available from BASF.

The water soluble polymer can be selected from the group of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyalkylene oxides such as polyethylene oxide; polyethylene glycols; acrylamide; acrylic acid; polyvinyl acetates; polycarboxylic acids; polyaminoacids or peptides; polyamides; polyacrylamide; copolymers of maleic/acrylic acids; In one embodiment the polymer comprises polyacrylates, especially sulfonated polyacrylates and water-soluble acrylate copolymers; and, polymethacrylates. In yet another embodiment the water soluble polymer can be selected from the group of PVA; PVA copolymers; and mixtures thereof.

The water soluble polymer can be selected from the group of polyvinyl alcohol, modified polyvinyl alcohol, polyvinyl pyrrolidone, polyvinyl alcohol/polyvinyl pyrrolidone, polyvinyl alcohol/polyvinyl amine, partially hydrolyzed polyvinyl acetate, polyalkylene oxide, polyethylene glycol, acrylamide, acrylic acid, polyvinyl acetates, polycarboxylic acids and salts, polyaminoacids or peptides, polyamides, polyacrylamide, copolymers of maleic/acrylic acids, polymethacrylates, polyvinyl alcohol copolymers, and mixtures thereof.

The water soluble carrier can be an organic material. Organic water soluble carriers may provide a benefit of being readily soluble in water.

The water soluble carrier can be selected from the group of polyethylene glycol, polypropylene glycol polyoxoalkylene, polyethylene glycol fatty acid ester, polyethylene glycol ether, nonionic starch, and mixtures thereof.

The water soluble carrier can be polyethylene glycol (PEG). PEG can be a convenient material to employ to make particles because it can be sufficiently water soluble to dissolve during a wash cycle when the particles have the range of mass disclosed herein. Further, PEG can be easily processed as melt. The onset of melt temperature of PEG can vary as a function of molecular weight of the PEG. The plurality of particles can comprise about 20% to about 94% by weight PEG having a weight average molecular weight from about 2000 Da to about 15000 Da. PEG has a relatively low cost, may be formed into many different shapes and sizes, and dissolves well in water. PEG comes in various weight average molecular weights. A suitable weight average molecular weight range of PEG includes from about 2000 Da to about 13000 Da, alternatively from about 4000 Da to about 13000 Da, alternatively from about 4000 Da to about 12000 Da, alternatively from about 4000 Da to about 11000 Da, alternatively from about 5000 Da to about 11000 Da, alternatively from about 6000 Da to about 10000 Da, alternatively from about 7000 Da to about 9000 Da, alternatively combinations thereof. PEG is available from BASF, for example PLURIOL E 8000, or other PLURIOL product. The water soluble carrier can be a mixture of two or more polyethylene glycol compositions, one having a first weight average molecular weight (e.g. 9000 Da) and the other having a second weight average molecular weight (e.g. 4000 Da), the second weight average molecular weight differing from the first weight average molecular weight.

The plurality of particles can comprise about 25% to about 94% by weight of the individual particles of PEG. Optionally, the plurality of particles can comprise from about 30% to about 92%, optionally from about 35% to about 90%, optionally from about 50% to about 80%, optionally combinations thereof and any whole percentages or ranges of whole percentages within any of the aforementioned ranges, of PEG by weight of the plurality of particles.

The water soluble carrier can comprise a material selected from the group of: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30; and mixtures thereof. The polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200, can be a block copolymer or random copolymer.

The water soluble carrier can comprise: polyethylene glycol; a polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; and a polyethylene glycol fatty alcohol ether of formula HO—(C₂H₄O)ₛ—(CH₂)ₜ)—CH₃ wherein s is from about 30 to about 250 and t is from about 10 to about 30.

The water soluble carrier can comprise from about 25% to about 94% by weight of the plurality of particles or by weight of the individual particles of polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200.

The water soluble carrier can comprise from about 1% to about 20% by weight of the plurality of particles or by weight of the individual particles polyethylene glycol fatty acid ester of formula (C₂H₄O)_{q}—C(O)O—(CH₂)ᵣ—CH₃ wherein q is from about 20 to about 200 and r is from about 10 to about 30.

The water soluble carrier can comprise from about 1% to about 10% by weight of the plurality of particles or by weight of the individual particles of polyethylene glycol fatty alcohol ether of formula HO—(C₂H₄O)ₛ—(CH₂)ₜ)—CH₃ wherein s is from about 30 to about 250 and t is from about 10 to about 30.

The water soluble carrier can comprise plasticizer polyol (from 0% to 3% by weight of the plurality of particles or by weight of the individual particles), wherein the plasticizer polymer is optionally a liquid at 20 C and 1 atmosphere of pressure; water (from 1% to 20%, or 1% to 12%, or 6% to 8%, by weight of the plurality of particles or by weight of the individual particles); sugar alcohol polyol selected from the group of erythritol, xylitol, mannitol, isomalt, maltitol, lactitol, trehalose, lactose, tagatose, sucralose, and mixtures thereof (from 45% to 80%, or 50% to 70%, or 50% to 60%, by weight of the plurality of particles or by weight of the individual particles); wherein the plurality of particles or individual particles further comprise: (a) modified starch that is not cationic having a dextrose equivalent from 15 to 20 and the sugar alcohol polyol and the modified starch are present at a weight ratio of the sugar alcohol polyol to the modified starch from 2:1 to 16:1, or from 2:1 to 10:1, or from 2:1 to 3:1; or (b) modified starch that is not cationic having a dextrose equivalent from 4 to less than 15 and the sugar alcohol polyol and the modified starch are present at a weight ratio of the sugar alcohol polyol to the modified starch from 1.5:1 to 16:1, or from 1.5:1 to 10:1, or from 1.5:1 to 4. The modified starch that is not cationic can have a dextrose equivalent from 15 to 20 and the sugar alcohol polyol and the modified starch can be present at a ratio from 2:1 to 16:1, or from 2:1 to 10:1, or from 2:1 to 3:1. The modified starch can have a dextrose equivalent from 4 to less than 15 and the sugar alcohol polyol and the modified starch can be present at a weight ratio of the sugar alcohol polyol to the modified starch from 1.5:1 to 16:1, or from 1.5:1 to 10:1, or from 1.5:1 to 4:1. The modified starch can have a dextrose equivalent from 4 to 12. The modified starch can be maltodextrin. The sugar alcohol polyol can be mannitol. The plasticizer polyol can be selected from the group of glycerin, dipropylene glycol, propylene glycol, and mixtures thereof.

The water soluble carrier can be selected from the group of a polyalkylene polymer of formula H—(C₂H₄O)ₓ—(CH(CH₃)CH₂O)_{y}—(C₂H₄O)_{z}—OH wherein x is from 50 to 300, y is from 20 to 100, and z is from 10 to 200; a polyethylene glycol fatty acid ester of formula (C₂H₄O)_{q}—C(O)O—(CH₂)ᵣ—CH₃ wherein q is from 20 to 200 and r is from 10 to 30; a polyethylene glycol fatty alcohol ether of formula HO—(C₂H₄O)ₛ—(CH₂)ₜ)—CH₃ wherein s is from 30 to 250 and t is from 10 to 30; C8-C22 alkyl polyalkoxylate comprising more than 40 alkoxylate units; polyethylene glycol having a weight average molecular weight from 2000 to 15000; EO/PO/EO block copolymer; PO/EO/PO block copolymer; EO/PO block copolymer; PO/EO block copolymer; polypropylene glycol; ethoxylated nonionic surfactant having a degree of ethoxylation greater than 30; polyvinyl alcohol; polyalkylene glycol having a weight average molecular weight from 2000 to 15000; and mixtures thereof.

### Adjunct

The plurality of particles can comprise additional adjunct ingredients. These additional adjunct ingredients can act as processing aids and modify particle properties such as solubility and rate of dissolution, dissolution stability, resistance to moisture pickup from humidity in storage, stretchability, feel, brittleness, and texture of the substrate, appearance and shine, and ease and speed of processing, casting, extruding, or drying the substrate, mechanical handling of the substrate, and storage of the substrate. The adjunct can be selected from the group of fatty acid, fatty alcohol, mono or diester fatty triglycerides, glyceryl diester of hydrogenated tallow, glyceryl monoester of hydrogenated tallow, glycerol, and combinations thereof. Additional adjunct ingredients can include colorants, dyes, solvents, germ killing materials, antioxidants, anti-mite materials, dye transfer inhibitors, and combinations thereof. Optionally, the colorants include at least one dye selected from those typically used in laundry detergent. Examples of suitable dyes include, but are not limited to, LIQUITINT BLUE BL, LIQUITINT PINK AM, AQUA AS CYAN 15, and VIOLET FL, available from Milliken Chemical.

### Cationic Polysaccharide

The particles can comprise a cationic polysaccharide. Cationic polysaccharides can provide the benefit of a deposition aid that helps to deposit onto the fabric the first hydrophobic conditioning compound, the optionally second hydrophobic conditioning compound, and possibly some other optional benefit agents that are contained in the particles.

The cationic polysaccharide can be dispersed in the water soluble carrier. The cationic polysaccharide can be uniformly dispersed or randomly dispersed in the water soluble carrier.

The particles can comprise about 0.5% to about 10% by weight cationic polysaccharide. Optionally, the particles can comprise about 0.5% to about 5% by weight cationic polysaccharide, or even about 1% to about 5% by weight, or even about 2% to about 4% by weight cationic polysaccharide, or even about 3% by weight cationic polysaccharide. Without being bound by theory, it is thought that the cleaning performance of laundry detergent in the wash decreases with increasing levels of cationic polysaccharide in the particles and acceptable cleaning performance of the detergent can be maintained within the aforesaid ranges.

The cationic polysaccharide can have a cationic charge density more than about 0.05 meq/g (meq meaning milliequivalents), to 23 meq/g, optionally from about 0.1 meq/g to about 4 meq/g, optionally from about 0.1 meq/g to about 2 meq/g, optionally from 0.1 meq/g to about 1 meq/g.

The above referenced cationic charge densities can be at the pH of intended use, which can be a pH from about 3 to about 9, optionally about 4 to about 9.

Cationic charge density of a cationic polysaccharide refers to the ratio of the number of positive charges on the cationic polysaccharide to the molecular weight of the cationic polysaccharide. Charge density is calculated by dividing the number of net charges per repeating unit by the molecular weight of the repeating unit. The positive charges may be located on the backbone of the polysaccharide and/or the side chains of polysaccharides. The average molecular weight of such suitable cationic polysaccharide can generally be between about 10000 Da and about 10 million Da, or even between about 50000 Da and about 5 million Da, or even between about 100000 Da and about 3 million Da.

Non-limiting examples of cationic polysaccharides include cationic cellulose derivatives, cationic guar gum derivatives, chitosan and its derivatives and cationic starches. Cationic polysaccharides have a molecular weight from about 1000 Da to about 2 million Da, optionally from about 100000 Da to about 800000 Da. Suitable cationic polysaccharides include cationic cellulose ethers, particularly cationic hydroxyethylcellulose and cationic hydroxypropylcellulose. Cationic polysaccharides can be cationic cellulosic polymers with substituted anhydroglucose units that correspond to the general structural formula as follows:

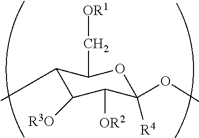

Wherein R¹, R², R³ are each independently selected from H, CH₃, C₈₋₂₄ alkyl (linear or branched),

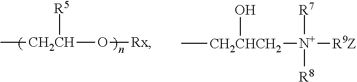

or mixtures thereof;
R⁴ is H,
n is from about 1 to about 10;
Rx is selected from the group of H, CH₃, C₈₋₂₄ alkyl (linear or branched),

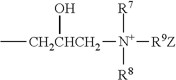

or mixtures thereof, wherein Z is a water soluble anion, optionally a chlorine ion and/or a bromine ion; R⁵ is H, CH₃, CH₂CH₃, or mixtures thereof; R⁷ is CH₃, CH₂CH₃, a phenyl group, a C₈₋₂₄ alkyl group (linear or branched), or mixture thereof; and
R⁸ and R⁹ are each independently CH₃, CH₂CH₃, phenyl, or mixtures thereof:
With the provisio that at least one of R¹, R², R³ groups per anhydroglucose unit is

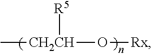

and each polymer has at least one

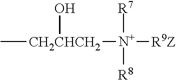

group.

The charge density of the cationic celluloses herein (as defined by the number of cationic charges per 100 anhydroglucose units) is optionally from about 0.5% to about 60%, more optionally from about 1% to about 20%, and optionally from about 2% to about 10%.

Alkyl substitution on the anhydroglucose rings of the polysaccharide ranges from about 0.01% to 5% per glucose unit, optionally from about 0.05% to 2% per glucose unit, of the polymeric material.

The cationic cellulose may be lightly cross-linked with a dialdehyde such as glyoxyl to prevent forming lumps, nodules or other agglomerations when added to water at ambient temperatures.

Examples of cationic hydroxyalkyl cellulose include those with the INCI name Polyquaternium10 such as those sold under the trade names UCARE Polymer JR 30M, JR 400, JR 125, LR 400 and LK 400, Polymer PK polymers; Polyquaternium 67 such as those sold under the trade name Softcat SK TM, all of which are marketed by Dow Chemicals, Midland MI, and Polyquaternium 4 such as those sold under the trade name CELQUAT H200 and CELQUAT L-200 available from National Starch and Chemical Company, Bridgewater, NJ. Other suitable polysaccharides include hydroxyethyl cellulose or hydoxypropyl cellulose quaternized with glycidyl C₁₂-C₂₂ alkyl dimethyl ammonium chloride. Examples of such polysaccharides include the polymers with the INCI names Polyquaternium 24 such as those sold under the trade name QUATERNIUM LM 200 by Dow Chemicals of Midland, MI. Cationic starches refer to starch that has been chemically modified to provide the starch with a net positive charge in aqueous solution at pH 3. This chemical modification includes, but is not limited to, the addition of amino and/or ammonium group(s) into the starch molecules. Non-limiting examples of these ammonium groups may include substituents such as trimethylhydroxypropyl ammonium chloride, dimethylstearylhydroxypropyl ammonium chloride, or dimethyldodecylhydroxypropyl ammonium chloride. The source of starch before chemical modification can be chosen from a variety of sources including tubers, legumes, cereal, and grains. Non-limiting examples of this source of starch may include corn starch, wheat starch, rice starch, waxy corn starch, oat starch, cassava starch, waxy barley, waxy rice starch, glutenous rice starch, sweet rice starch, amioca, potato starch, tapioca starch, oat starch, sago starch, sweet rice, or mixtures thereof. Nonlimiting examples of cationic starches include cationic maize starch, cationic tapioca, cationic potato starch, or mixtures thereof. The cationic starches may comprise amylase, amylopectin, or maltodextrin. The cationic starch may comprise one or more additional modifications. For example, these modifications may include cross-linking, stabilization reactions, phophorylations, hydrolyzations, cross-linking. Stabilization reactions may include alkylation and esterification. Suitable cationic starches for use in the present compositions are commercially-available from Cerestar under the trade name C*BOND and from National Starch and Chemical Company under the trade name CATO 2A. Cationic galactomannans include cationic guar gums or cationic locust bean gum. In another aspect, the cationic polysaccharide may be selected from the group of cationic polysaccharides. In one aspect, the cationic polysaccharide may be selected from the group of cationic cellulose ethers, cationic galactomanan, cationic guar gum, cationic starch, cationic dextrin, cationic chitosan, cationic inulin, cationic cassia and combinations thereof.

In another aspect, the cationic polysaccharide may be selected from cationic hydroxyalkyl guar, such as cationic hydroxyethyl guar, cationic hydroxypropyl guar, cationic hydroxybutyl guar, and cationic carboxyalkyl guars, including cationic carboxymethyl guar; cationic alkylcarboxyl guars, such as cationic carboxypropyl guar and cationic carboxybutyl guar, cationic carboxymethylhydroxypropyl guar. In one exemplary embodiment, the cationic guar of the present invention is guar hydroxypropyltrimonium chloride or hydroxypropyl guar hydroxypropyltrimonium chloride.

An example of a cationic guar gum is a quaternary ammonium derivative of Hydroxypropyl Guar such as those sold under the trade name JAGUAR C-500, JAGUAR C13 and JAGUAR Excel available from Rhodia, Inc of Cranbury NJ and N-Hance by Aqualon, Wilmington, DE.

Other suitable cationic polymers include cationic guar gum derivatives, such as guar hydroxypropyltrimonium chloride, specific examples of which include the Jaguar® series commercially available from Rhone-Poulenc Incorporated and the N-Hance® series commercially available from Aqualon Division of Hercules, Inc.

The weight-average molecular weight of the cationic polysaccharide may be from about 500 Da to about 5000000 Da, or from about 1000 Da to about 2000000 Da, or from about 5000 Da to about 1000000 Da Daltons, as determined by size exclusion chromatography relative to polyethylene oxide standards with RI detection. In one aspect, the weight-average molecular weight of the cationic polysaccharide may be from about 100000 Da to about 800000 Da.

The cationic polysaccharide can be provided in a powder form. The cationic polysaccharide can be provided in an anhydrous state.

### Hydrophobic Conditioning Compounds

The plurality of particles can comprise a first hydrophobic conditioning compound and an optional second hydrophobic conditioning compound. Optionally, the first hydrophobic conditioning compound and said second hydrophobic conditioning compound together can constitute from about 6% to about 45% by weight of said composition. The first hydrophobic conditioning compound can have a weight average molecular weight greater than 1000 Da. The optional second hydrophobic conditioning compound can have a weight average molecular weight greater than 1000 Da. The plurality of particles can comprise from about 5% to about 45%, optionally from about 8% to about 15%, optionally from about 5% to about 30%, optionally from about 5% to about 20%, optionally from about 8% to about 25%, by weight the first hydrophobic conditioning compound.

The plurality of particles can comprise from about 5% to about 45%, optionally from about 8% to about 15%, optionally from about 5% to about 30%, optionally from about 5% to about 20%, optionally from about 8% to about 25%, by weight the second hydrophobic conditioning compound.

The first hydrophobic conditioning compound can be dispersed in the water soluble carrier. The second hydrophobic conditioning compound can be dispersed in the water soluble carrier. Both the first hydrophobic conditioning compound and second hydrophobic conditioning compound can be dispersed in the water soluble carrier. The first hydrophobic conditioning compound and option second hydrophobic conditioning compound can be uniformly dispersed or randomly dispersed in the water soluble carrier.

A) The first hydrophobic conditioning compound and or second hydrophobic conditioning compound can be a branched polyester selected from the group of:
(a) a branched polyester having Formula 1

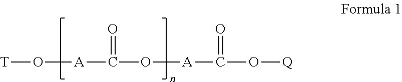

wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
(b) a branched polyester having Formula 2

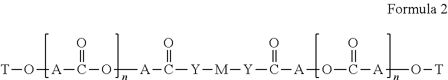

wherein:
each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group of oxygen and NR2, wherein each R2 is independently selected from the group of hydrogen, or a C1-C8 alkyl; and
M is a polyalkylene glycol group;
(c) a branched polyester having Formula 3

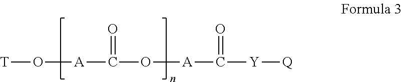

wherein:
the index n is an integer from 1 to about 100, optionally the index n is an integer from 4 to about 40, optionally the index n is an integer from 5 to about 20;
T is a hydrogen or —C(O)—R1 where in R1 is an alkyl chain comprising from 7 to 21 carbon atoms, optionally R1 is an alkyl chain comprising from 11 to 17 carbon atoms;
each A is independently a branched hydrocarbon chain comprising from 4 to 40 carbon atoms, optionally from 12 to 20 carbon atoms, optionally 17 carbon atoms;
Y is selected from the group of oxygen and NR2, wherein each R2 is independently selected from the group of hydrogen, or a C1-C8 alkyl, optionally, Y is selected from —O— and

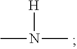

Q is selected from the group of:
i) -B
ii) Z-X-Z-W, and
iii) V-U-Z-X-Z-W
optionally, Q is selected from the group of:
i) -B, and
ii) -Z-X-Z-W
wherein
B is a substituted C1-C24 alkyl group, optionally the substituents are selected from the group of hydroxyl, primary amine, secondary amine, tertiary amine, quaternary ammonium group and mixtures thereof, more optionally B comprises from 1 to 4 substituents selected from the group of hydroxyl, primary amine, secondary amine, tertiary amine, quaternary ammonium group and mixtures thereof;
each Z is independently a substituted or unsubstituted divalent C2-C40 alkylene radical, optionally each Z is independently a substituted or unsubstituted divalent C2-C20 alkylene, most optionally each Z is independently selected from the group of:

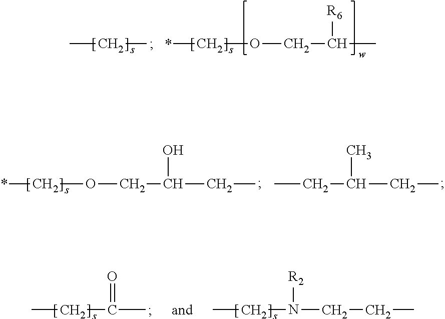

wherein * signifies a bond of the Z moiety to a X moiety of the branched polyester;
each R2 is independently selected from the group of hydrogen or a C1-C8 alkyl;
each R6 is independently selected from the group of hydrogen, or a C1-C3 alkyl, optionally a hydrogen or methyl;
each s is independently an integer from about 2 to about 8, optionally each s is independently an integer from about 2 to about 4;
each w is independently an integer from 1 to about 20, optionally each w is independently an integer from 1 to about 10, more optionally each w is independently an integer from 1 to about 8; X is polysiloxane moiety, optionally X has the formula

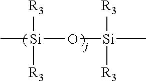

wherein each R3 is independently selected from the group of H; C1-C32 alkyl; C1-C32 substituted alkyl, C5-C32 or C6-C32 aryl, C5-C32 or C6-C32 substituted aryl; C6-C32 alkylaryl, C6-C32 substituted alkylaryl, and C1-C32 alkoxy moieties, optionally each R3 is independently selected from H; C1-C16 alkyl; C1-C16 substituted alkyl substituted with amino, hydroxyl, carboxyl or polyether moieties, optionally, each R3 is independently selected from H, methyl and methoxy groups; and
j is an integer from 5 to about 1000, optionally j is an integer from about 10 to 500, optionally j is an integer from about 20 to 300;
W is selected from the group of —OR4,

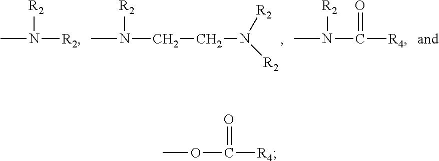

each R2 is independently selected from the group of hydrogen or a C1-C8 alkyl;
R4 is selected from a hydrogen atom, a C1-C24 alkyl group or a substituted C1-C24 alkyl group, optionally the substituents being from 1 to 4 functional moieties selected from the group of hydroxyl, primary amine, secondary amine, tertiary amine, quaternary ammonium group and mixtures thereof, C5-C32 or C6-C32 aryl, C5-C32 or C6-C32 substituted aryl; C6-C32 alkylaryl, and C6-C32 substituted alkylaryl, optionally R4 is selected from a hydrogen atom, a C1-C24 alkyl group or a substituted C1-C24 alkyl group, optionally the substituents being from 1 to 4 functional moieties selected from the group of hydroxyl, primary amine, secondary amine, tertiary amine, quaternary ammonium group and mixtures thereof;
V is a C1-C24 divalent alkylene radical or a substituted C1-C24 divalent alkylene, optionally the substituents being from 1 to 4 functional moieties selected from the group of hydroxyl, primary amine, secondary amine, tertiary amine, quaternary ammonium group and mixtures thereof; U is —C(O)O— or —C(O)NH—; and/or
(d) a branched polyester having Formula 4

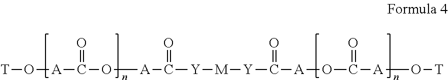

wherein:
   each index n is independently an integer from 1 to about 100;
   T is a hydrogen atom or —C(O)—R₁ where in R₁ is an alkyl chain comprising from 7 to 21 carbon atoms, optionally from 11 to 17 carbon atoms;
   each A is independently a branched hydrocarbon chain comprising from 4 to 40 carbon atoms, optionally from 12 to 20 carbon atoms, optionally 17 carbon atoms;
   each Y is independently selected from the group of oxygen and NR₂, wherein each R₂ is independently selected from the group of hydrogen or a C1-C8 alkyl;
   M is selected from the group of:
i) a C₁-C₂₄ divalent linear or branched alkylene radical, optionally the C₁-C₂₄ divalent linear or branched alkylene radical comprises one to four functional groups selected from the group of hydroxyl, primary amine, secondary amine, tertiary amine, quaternary ammonium group and mixtures thereof; optionally the C₁-C₂₄ divalent linear or branched alkylene radical has the formula:

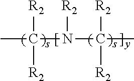

wherein each R₂ is independently selected from the group of hydrogen or a C₁-C₈ alkyl; each s is independently an integer from about 2 to about 10, optionally each s is independently an integer from about 2 to about 8, optionally each s is independently an integer from about 2 to about 4; y is an integer from about 1 to about 20;
ii) -Z-X-Z, and
iii) --(D--U-Z-X-Z--U)ₘ-D-
   wherein:
      m is an integer from 1 to about 10;
      each Z is independently a substituted or unsubstituted divalent C₂-C₄₀ alkylene radical, optionally each Z is independently a substituted or unsubstituted divalent C₂-C₂₀ alkylene, optionally each Z is independently selected from the group of:

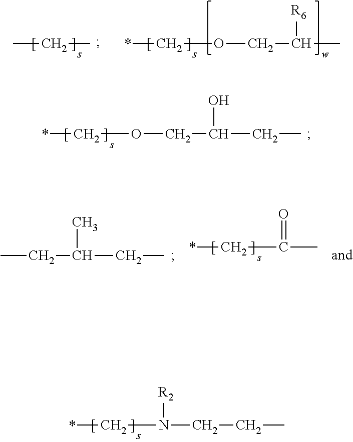

wherein * signifies a bond of the the Z moiety to a X moiety of the branched polyester;
each R₂ is independently selected from the group of hydrogen or a C₁-C₈ alkyl;
each R₆ is independently selected from the group of hydrogen, or a C₁-C₃ alkyl, optionally a hydrogen or methyl;
each s is independently an integer from about 2 to about 8, optionally each s is independently an integer from about 2 to about 4;
each w is independently an integer from 1 to about 20, optionally each w is independently an integer from 1 to about 10, optionally each w is independently an integer from 1 to about 8;
X is polysiloxane moiety, optionally X has the formula:

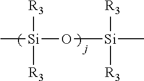

wherein each R₃ is independently selected from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl; C₆-C₃₂ alkylaryl, C₆-C₃₂ substituted alkylaryl, and C₁-C₃₂ alkoxy moieties, optionally each R₃ is independently selected from H; C₁-C₁₆ alkyl; C₁-C₁₆ substituted alkyl substituted with amino, hydroxyl, carboxyl or polyether moieties, optionally, each R₃ is independently selected from H, methyl and methoxy groups; and
j is an integer from 5 to about 1000, optionally j is an integer from about 20 to 500;
U is —C(O)O— or —C(O)NH—; and
each D is independently a C₁-C₂₄ divalent linear or branched alkylene radical, the alkylene radical optionally the C₁-C₂₄ divalent linear or branched alkylene radical comprises one to four functional groups selected from the group of hydroxyl, primary amine, secondary amine, tertiary amine, quaternary ammonium group and mixtures thereof;
optionally the C₁-C₂₄ divalent linear or branched alkylene radical has the formula:

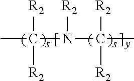

wherein each R₂ is independently selected from the group of hydrogen or a C₁-C₈ alkyl; each s is independently an integer from about 2 to about 10, optionally each s is independently an integer from about 2 to about 8, optionally each s is independently an integer from about 2 to about 4; y is an integer from about 1 to about 20;
(e) and mixtures thereof;

The polyhydroxystearic acid of Formula 1 can be HYPERMER LP1, available from Croda Inc & Sederma Inc., Edison, New Jersey, United States of America. They polyhydroxystearic acid of Formula 1 can be SALACOS HS-4C, available from Nisshin Oillio Group, Ltd., Tokyo, Japan. They polyhydroxystearic acids of Formula 2 can be HYPERMER B261, HYPERMER B210, and HYPERMER B246, available from Croda Inc & Sederma Inc., Edison, New Jersey, United States of America.

B) The first hydrophobic conditioning compound and or second hydrophobic conditioning compound can be a branched polyester selected from the group of:
(a) the branched polyester of the Formula 1

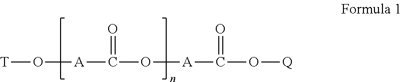

wherein:
each A is independently a branched hydrocarbon chain comprising from 4 to 40 carbon atoms, optionally from 12 to 20 carbon atoms, optionally 17 carbon atoms;
Q is selected from an alkyl chain comprising 1 to 30 carbon atoms and a hydrogen atom, optionally Q is a hydrogen atom;
T is a hydrogen atom or a —C(O)—R wherein each R is an alkyl chain comprising from 7 to 21 carbon atoms, optionally from 11 to 17 carbon atoms; and
n is an integer from 1 to 100, optionally n is an integer from 5 to 20;
(b) the branched polyester of the Formula 2

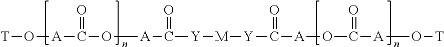

wherein:
n is an integer from 4 to 40, optionally n is an integer from 5 to 20
each A is independently a branched hydrocarbon chain comprising from 4 to 40 carbon atoms, optionally from 12 to 20 carbon atoms, optionally 17 carbon atoms
each T is independently a hydrogen atom or a —C(O)—R wherein each R is an alkyl chain comprising from 7 to 21 carbon atoms, optionally from 11 to 17 carbon atoms;
each Y is independently a linking group selected from the group of oxygen and NR2, wherein each R2 is independently selected from the group consisting of hydrogen, or a C₁-C₈ alkyl, optionally each R2 is hydrogen;
M is a polyalkylene glycol group, optionally M has the structure

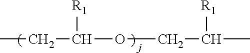

wherein
each R1 is selected from hydrogen, methyl and ethyl; and
j is an integer from 0 to about 400, optionally from 2 to about 50;
(c) and mixtures thereof.

C) The first hydrophobic conditioning compound and or second hydrophobic conditioning compound can be according to any of Paragraphs A) through B) wherein the branched polyester polymer having Formula 1 and Formula 2 each have a weight average molecular weight of from about 1000 Da to about 100000 Da, optionally from about 1000 Da to about 60000 Da, optionally from about 1000 Da to about 10000 Da, optionally from about 1000 Da to about 5000 Da.

D) The first hydrophobic conditioning compound and or second hydrophobic conditioning compound can be according to any of Paragraphs A) through C), wherein each A of the polyester polymers is independently a branched hydrocarbon having the structure

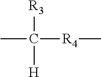

wherein each R3 is a monovalent alkyl or substituted alkyl group and R4 is an unsaturated or saturated divalent alkylene radical comprising from 1 to about 24 carbon atoms, optionally each R3 is a monovalent alkyl radical comprising 6 carbon atoms and each R4 is an unsaturated or saturated divalent alkylene radical comprising from 10 carbon atoms.

E) The first hydrophobic conditioning compound and or second hydrophobic conditioning compound can be according to any of Paragraphs A) through D), wherein each A of the polyester polymers has the structure:

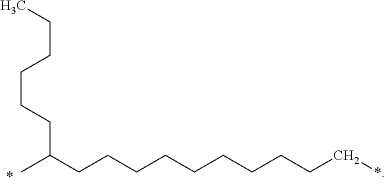

F) The first hydrophobic conditioning compound and or second hydrophobic conditioning compound can be according to any of Paragraphs A) through E) wherein the branched polyester polymer has an iodine value from about 0 to about 90, optionally from about 0.4 to about 50 an optionally from about 1 to about 30.

The first hydrophobic conditioning compound or second hydrophobic conditioning compound can be a silicone. Useful silicones can be any silicone comprising compound. In one embodiment, the silicone is a silicone polymer selected from the group of cyclic silicones, polydimethylsiloxanes, aminosilicones, cationic silicones, silicone polyethers, silicone resins, silicone urethanes, and mixtures thereof. In one embodiment, the silicone is a polydialkylsilicone, alternatively a polydimethyl silicone (polydimethyl siloxane or “PDMS”), or a derivative thereof. In another embodiment, the silicone is chosen from an aminofunctional silicone, polyether silicone, alkyloxylated silicone, cationic silicone, ethoxylated silicone, propoxylated silicone, ethoxylated/propoxylated silicone, or combinations thereof.

In another embodiment, the silicone may be chosen from a random or blocky organosilicone polymer having the following formula:

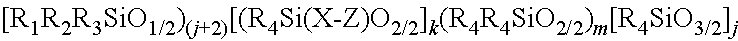

wherein:
j is an integer from 0 to about 98; in one aspect j is an integer from 0 to about 48; in one aspect, j is 0;
k is an integer from 0 to about 200, in one aspect k is an integer from 0 to about 50; when k=0, at least one of R₁, R₂ or R₃ is -X-Z;
m is an integer from 4 to about 5000; in one aspect m is an integer from about 10 to about 4000; in another aspect m is an integer from about 50 to about 2000;
R₁, R₂ and R₃ are each independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X-Z;
each R₄ is independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
each X in the alkyl siloxane polymer comprises a substituted or unsubsitituted divalent alkylene radical comprising 2-12 carbon atoms, in one aspect each divalent alkylene radical is independently selected from the group of —(CH₂)ₛ— wherein s is an integer from about 2 to about 8, from about 2 to about 4; in one aspect, each X in the alkyl siloxane polymer comprises a substituted divalent alkylene radical selected from the group of: —CH₂—CH(OH)—CH₂—; —CH₂—CH₂—CH(OH)—; and

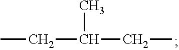

each Z is selected independently from the group of

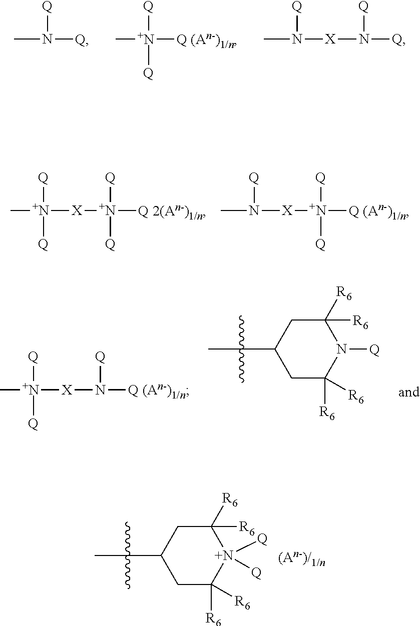

and with the proviso that when Z is a quat, Q cannot be an amide, imine, or urea moiety and if Q is an amide, imine, or urea moiety, then any additional Q bonded to the same nitrogen as the amide, imine, or urea moiety must be H or a C₁-C₆alkyl, in one aspect, the additional Q is H; for Z Aⁿ⁻ is a suitable charge balancing anion. In one aspect Aⁿ⁻ is selected from the group of Cl⁻, Br⁻, I⁻, methylsulfate, toluene sulfonate, carboxylate and phosphate; and at least one Q in the organosilicone is independently selected from —CH₂—CH(OH)—CH₂—R₅;

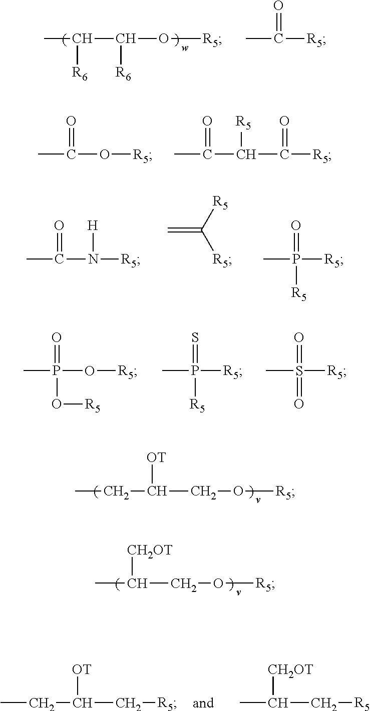

each additional Q in the organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —CH₂—CH(OH)—CH₂—R₅;

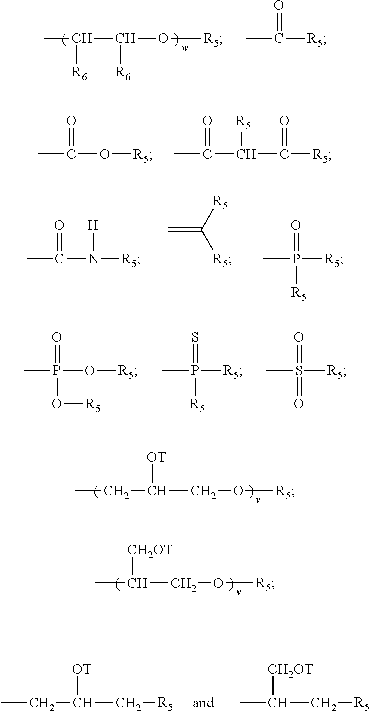

wherein each R₅ is independently selected from the group of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, -(CHR₆—CHR₆—O—)_{w}-L and a siloxyl residue;
each R₆ is independently selected from H, C₁-C₁₈ alkyl;
each L is independently selected from —C(O)—R₇ or;
R₇;
w is an integer from 0 to about 500, in one aspect w is an integer from about 1 to about 200; in one aspect w is an integer from about 1 to about 50;
each R₇ is selected independently from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl; C₆-C₃₂ substituted alkylaryl and a siloxyl residue;
each T is independently selected from H, and

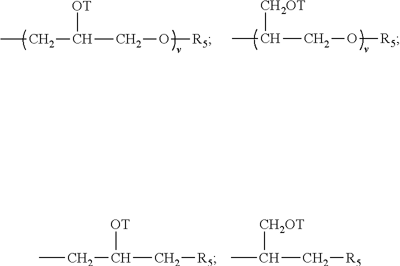

and
wherein each v in the organosilicone is an integer from 1 to about 10, in one aspect, v is an integer from 1 to about 5 and the sum of all v indices in each Q in the organosilicone is an integer from 1 to about 30 or from 1 to about 20 or even from 1 to about 10.

In another embodiment, the silicone may be chosen from a random or blocky organosilicone polymer having the following formula:

[R₁R₂R₃SiO_{1/2}]₍ⱼ₊₂₎[(R₄Si(X-Z)O_{2/2}]ₖ[R₄R₄SiO_{2/2}]ₘ[R₄SiO_{3/2}]ⱼ
wherein
j is an integer from 0 to about 98; in one aspect j is an integer from 0 to about 48; in one aspect, j is 0;
k is an integer from 0 to about 200; when k=0, at least one of R₁, R₂ or R₃=-X-Z, in one aspect,
k is an integer from 0 to about 50
m is an integer from 4 to about 5000; in one aspect m is an integer from about 10 to about 4000; in another aspect m is an integer from about 50 to about 2000;
R₁, R₂ and R₃ are each independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X-Z;
each R₄ is independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
each X comprises of a substituted or unsubstituted divalent alkylene radical comprising 2-12 carbon atoms; in one aspect each X is independently selected from the group of —(CH₂)ₛ—O—; —CH₂—CH(OH)—CH₂—O—;

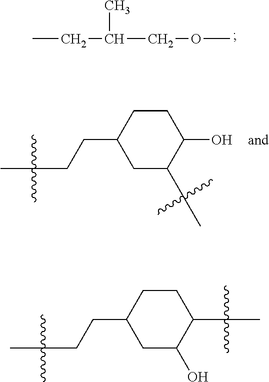

wherein each s independently is an integer from about 2 to about 8, in one aspect s is an integer from about 2 to about 4;
at least one Z in the organosiloxane is selected from the group of R₅; v

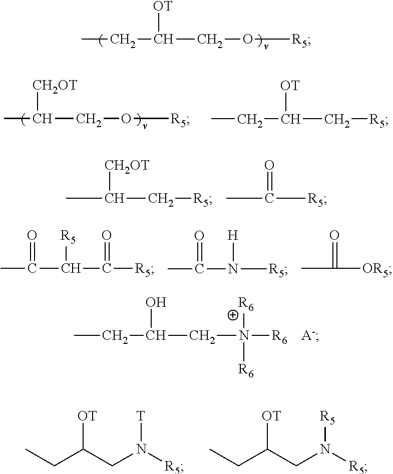

—C(R₅)₂O—R₅; —C(R₅)₂S—R₅ and

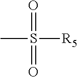

provided that when X is

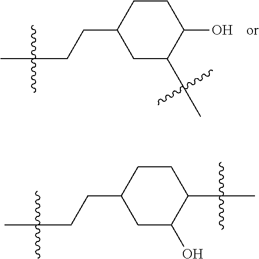 [SMILES: *CCC1CCC(O)C(*)C1 ; *CCC1CCC(*)C(O)C1]

then Z=—OR₅ or

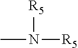

wherein A⁻ is a suitable charge balancing anion. In one aspect A- is selected from the group of Cl⁻, Br⁻, I⁻, methylsulfate, toluene sulfonate, carboxylate and phosphate and each additional Z in the organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, R₅,

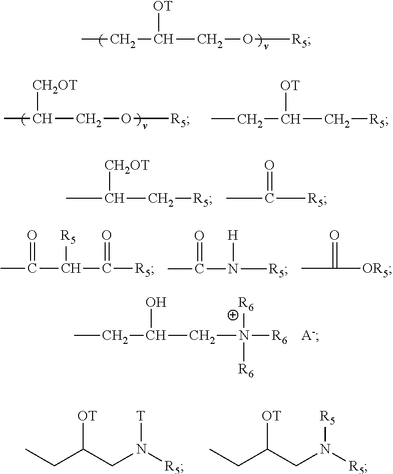

C(R₅)₂)O—R₅; —C(R₅)₂S—R₅ and

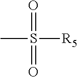

provided that when X is

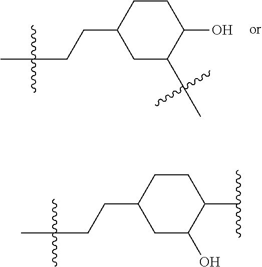 [SMILES: *CCC1CCC(O)C(*)C1 ; *CCC1CCC(*)C(O)C1]

then Z=—OR₅ or

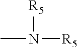

each R₅ is independently selected from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl,
—(CHR₆—CHR₆—O—)_{w}—CHR₆—CHR₆-L and siloxyl residue wherein each L is independently selected
from —O—C(O)-R₇ or —O—R₇;

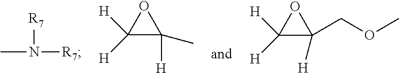

w is an integer from 0 to about 500, in one aspect w is an integer from 0 to about 200, one aspect
w is an integer from 0 to about 50;
each R₆ is independently selected from H or C₁-C₁₈ alkyl;
each R₇ is independently selected from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted aryl, and a siloxyl residue;
each T is independently selected from H;

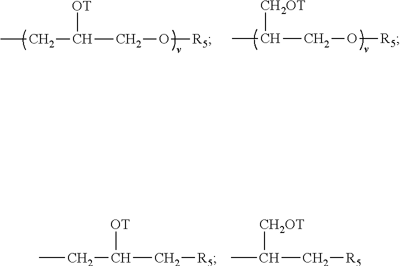

wherein each v in the organosilicone is an integer from 1 to about 10, in one aspect, v is an integer from 1 to about 5 and the sum of all v indices in each Z in the organosilicone is an integer from 1 to about 30 or from 1 to about 20 or even from 1 to about 10.

The silicone can be one comprising a relatively high molecular weight. A suitable way to describe the molecular weight of a silicone includes describing its viscosity. A high molecular weight silicone is one having a viscosity of from about 10 cSt to about 3000000 cSt, or from about100 cSt to about 1000000 cSt, or from about 1000 cSt to about 600000 cSt, or even from about 6000 cSt to about 300000 cSt.

### Salt

The plurality of particles can comprise from about 5% to about 50%, optionally from 8% to 25%, optionally from 15% to 30% by weight, said nonhalide salt, including any range within one of the aforesaid ranges as bounded by whole numbers of percent. For example, the plurality of particles can comprise from about 5% to about 50% by weight nonhalide salt, optionally from about 5% to about 30% by weight nonhalide salt, optionally from about 5% to about 25% by weight nonhalide salt, optionally from about 8% to about 24% by weight nonhalide salt, including any range within one of the aforesaid ranges as bounded by whole numbers of percent. The plurality of particles can comprise from about 10% to about 24% by weight nonhalide salt, optionally from about 15% to about 23% by weight nonhalide salt, optionally from about 18% to about 22% by weight nonhalide salt, including any range within one of the aforesaid ranges as bounded by whole numbers of percent. Optionally, the particles can comprise from about 25% to about 81% by weight the water soluble carrier and from about 8% to about 25% by weight nonhalide salt.

The nonhalide salt can be selected from alkali metal salt, an alkaline earth metal salt, an inorganic alkali metal salt, an organic alkali metal salt, an organic alkaline earth metal salt, or any combination thereof. The nonhalide salt can be an acidic salt, a basic salt, a carbonate salt, a carboxylate salt, a sulfate, nitrate salt, a citrate salt, or any combination thereof.

The nonhalide alkaline earth metal salts can include, for example, magnesium sulfate, magnesium phosphate, magnesium monohydrogen phosphate, magnesium dihydrogen phosphate, magnesium, carbonate, magnesium monohydrogen carbonate, magnesium acetate, magnesium citrate, magnesium lactate, magnesium tartrate, magnesium silicate, magnesium ascorbate, calcium sulfate, calcium phosphate, calcium monohydrogen phosphate, calcium dihydrogen phosphate, calcium carbonate, calcium monohydrogen carbonate, calcium acetate, calcium citrate, calcium lactate, calcium tartrate, calcium silicate, calcium ascorbate, or any combination thereof.

The salt can be a nonhalide salt. The nonhalide salt and its hydrates can be selected from the group of magnesium sulfate, ammonium sulfate, ammonium nitrate ammonium acetate, magnesium acetate, zinc sulfate monohydrate, magnesium sulfate heptahydrate, sodium acetate, sodium acetate trihydrate, calcium acetate, calcium acetate dihydrate, calcium sulfate, aluminum sulfate, zinc acetate, magnesium nitrate hexahydrate, magnesium acetate tetrahydrate, sodium sulfate decahydrate, sodium citrate, sodium carbonate, calcium citrate, calcium citrate tetrahydrate, and combinations thereof.

The nonhalide salt can be dispersed in the water soluble carrier. The nonhalide salt can be uniformly dispersed or randomly dispersed in the water soluble carrier. The nonhalide salts are characterized by a particle size less than 600 microns, optionally from 50 microns to 600 microns, optionally from 50 microns to 420 microns. The mean particle size of the nonhalide salts can be characterized by passing the salt material through sieves having different mesh sizes.

The nonhalide salt can chemically differ from the water soluble carrier.

### Nonionic Surfactants

The nonionic surfactant can be selected from alcohol alkoxylate non-ionic surfactant, including naturally derived alcohol, synthetic derived alcohol based alcohol alkoxylate non-ionic surfactants, and mixtures thereof, pending the desired average alkyl carbon chain length and average degree of branching. The alcohol alkoxylate nonionic surfactant can be a primary or a secondary alcohol alkoxylate nonionic surfactant, optionally a primary alcohol alkoxylate nonionic surfactant. Synthetically derived alcohol alkoxylate non-ionic surfactants include Ziegler-synthesized alcohol alkoxylate, an oxo-synthesized alcohol alkoxylate, a modified oxo-process synthesized alcohol alkoxylate, Fischer-Tropsch synthesized alcohol alkoxylates, Guerbet alcohol alkoxylates, alkyl phenol alcohol alkoxylates, or a mixture thereof. The alkoxylation chain can be a mixed alkoxylation chain comprising ethoxy, propoxy and/or butoxy units, or can be a purely ethoxylated alkyl chain, optionally a purely ethoxylated alkyl chain.

Suitable nonionic surfactant may include alkoxylated fatty alcohols. The nonionic surfactant may be selected from ethoxylated alcohols and ethoxylated alkyl phenols of the formula R(OC2H4), OH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15.

Other non-limiting examples of nonionic surfactants useful herein include: C8-C18 alkyl ethoxylates, such as, NEODOL nonionic surfactants from Shell; C6-C12 alkyl phenol alkoxylates where the alkoxylate units may be ethyleneoxy units, propyleneoxy units, or a mixture thereof; C12-C18 alcohol and C6-C12 alkyl phenol condensates with ethylene oxide/propylene oxide block polymers such as PLURONIC from BASF; C14-C22 mid-chain branched alcohols, BA; C14-C22 mid-chain branched alkyl alkoxylates, BAEX, wherein x is from 1 to 30; alkylpolysaccharides; specifically alkylpolyglycosides; polyhydroxy fatty acid amides; and ether capped poly(oxyalkylated) alcohol surfactants. Specific examples include C11-C15 E012 and C11-C15 E09 TERGITOL nonionic surfactants from Dow, C12-C15 E07 and C14-C15 E07 NEODOL nonionic surfactants from Shell, C12-C14 E07 and C12-C14 EO9 SURFONIC nonionic surfactants from Huntsman. Other suitable nonionic surfactants are the condensation products of Guerbet alcohols with from 2 to 18 moles, optionally 2 to 15, optionally 5-9 of ethylene oxide per mole of alcohol. Suitable nonionic surfactants include those with the trade name LUTENSOL from BASF. LUTENSOL XP-50 is a Guerbet ethoxylate that contains 5 ethoxy groups. LUTENSOL XP-80 and containing 8 ethoxy groups. Other suitable non-ionic surfactants for use herein include fatty alcohol polyglycol ethers, alkylpolyglucosides and fatty acid glucamides, and/or alkylpolyglucosides based on Guerbet alcohols.

The nonionic surfactant may comprise linear surfactants, branched surfactants, or mixtures thereof, optionally linear nonionic surfactants, branched nonionic surfactants, or mixtures thereof. Suitable linear surfactants may include C12-C14 E09 SURFONIC (ex Huntsman). Suitable branched surfactants may include TERGITOL 15-S-3 (ex Dow), TERGITOL 15-5-5 (ex Dow), TERGITOL 15-S-9 (ex Dow), TERGITOL 15-S-12 (ex Dow), and LUTENSOL XL70 (ex BASF).

A suitable nonionic surfactant can have a HLB from 8 to 15. Optionally, a suitable nonionic surfactant can have a molecular weight less than 1000 Da.

Without being bound by theory, it is thought that including a nonionic surfactant as described herein can help to slow down or limit crystallization of the hydrophobic conditioning compound when the hydrophobic conditioning compound is provided as part of a premix or in the precursor material from which the particles are formed. Crystallization of the hydrophobic conditioning compound in the premix or in the precursor material from which the particles are formed can affect the viscosity of the melt from which the plurality of particles are produced. Viscosity of the melt from which the particles are produced can affect the formation of the particles. Moreover, it is thought that a nonionic surfactant can limit the particle size of crystallized hydrophobic conditioning compound which can help reduce fabric staining and improve the softness when such particles are used in the wash.

As part of the process for forming the particles, a premix of the nonionic surfactant and hydrophobic conditioning compound, and optionally additional particle formulation components, can be provided. The premix can comprise the nonionic surfactant and hydrophobic conditioning compound in the desired weight fractions. The premix can comprise from about 20% to about 98% by weight the first hydrophobic conditioning compound and from about 2% to about 80% by weight the nonionic surfactant. Optionally, the premix can comprise from about 50% to about 70% by weight the first hydrophobic conditioning compound and from about 30% to about 50% by weight the nonionic surfactant. Optionally, additional formulation components including, but not limited to, cationic polysaccharide, and an optional nonhalide salt can be included in the premix. The premix of the aforesaid ingredients can be heated and mixed at a temperature from about 65° C. to about 85° C. The premix can be added to a melt of the water soluble carrier to form the precursor material from which particles are formed. The premix and the melt of water soluble carrier can be mixed to form the precursor material and the precursor material can then be used to manufacture the particles, as further described herein.

### Particles

The individual particles constituting the plurality of particles can have individual mass from about 1 mg to about 1 g. The smaller the individual particles the faster they tend to dissolve in water. The individual particles constituting the plurality of particles can have an individual or mean particle mass of from about 1 mg to about 1000 mg, alternatively from about 5 mg to about 500 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg. The individual particles constituting the plurality of particles can have standard deviation of mass of less than about 30 mg, alternatively less than about 15 mg, alternatively less than about 5 mg, alternatively about 3 mg. The mean particle of mass within the aforesaid ranges can provide for a dispersion time in water that permits the particles to dissolve during a typical wash cycle. Without being bound by theory, it is thought that particles have such a standard deviation of mass can have a more uniform dispersion time in water as compared to particles having a broader standard deviation of mass. The smaller the standard deviation of mass of the particles the more uniform the dispersion time. The mass of the individual particles forming the plurality particles can be set to provide the desired dispersion time, which might be some fraction of the length of the typical washing cycle in a washing machine.

The plurality of particles can be substantially free from particles having a mass less than 10 mg. This can be practical for limiting the ability of the particles to become airborne.

An individual particle may have a volume from about 0.003 cm³ to about 5 cm³, optionally from about 0.003 cm³ to about 1 cm³, optionally from about 0.003 cm³ to about 0.5 cm³, optionally from about 0.003 cm³ to about 0.2 cm³, optionally from about 0.003 cm³ to about 0.15 cm³. Smaller particles are thought to provide for better packing of the particles in a container and faster dissolution in the wash.

The composition can comprise individual particles that are retained on a number 10 sieve as specified by ASTM International, ASTM E11-13. The composition can comprise individual particles wherein more than about 50% by weight, optionally more than about 70% by weight, optionally more than about 90% by weight, of the individual particles are retained on a number 10 sieve as specified by ASTM International, ASTM E11-13. It can be desirable to provide individual particles sized as such because individual particles retained on a number 10 sieve may be easier to handle than smaller individual particles.

The composition can comprise individual particles that are retained on a number 6 sieve as specified by ASTM International, ASTM E11-13. The composition can comprise individual particles wherein more than about 50% by weight, optionally more than about 70% by weight, optionally more than about 90% by weight, of the individual particles are retained on a number 6 sieve as specified by ASTM International, ASTM E11-13. It can be desirable to provide individual particles sized as such because individual particles retained on a number 6 sieve may be easier to handle than smaller individual particles.

The composition can comprise individual particles that pass a sieve having a nominal sieve opening size of 22.6 mm. The composition can comprise individual particles that pass a sieve having a nominal sieve opening size of 22.6 mm and are retained on a sieve having a nominal sieve opening size of 0.841 mm. Individual particles having a size such that they are retained on a sieve having a nominal opening size of 22.6 mm may tend to have a dispersion time that is too great for a common wash cycle. Individual particles having a size such that they pass a sieve having a nominal sieve opening size of 0.841 mm may be too small to conveniently handle. Individual particles having a size within the aforesaid bounds may represent an appropriate balance between dispersion time and ease of particle handling.

Individual particles having the size disclosed herein can be substantial enough so that they do not readily become airborne when poured from a container, dosing cup, or other apparatus, into a wash basin or washing machine. Further, such individual particles as disclosed herein might be able to be easily and accurately poured from a container into a dosing cup. So, such individual particles may make it easy for the consumer to control the amount of first hydrophobic conditioning compound and optional second hydrophobic conditioning compound he or she delivers to the wash.

A plurality of particles may collectively comprise a dose for dosing to a laundry washing machine or laundry wash basin. A single dose of the plurality of particles may comprise from about 1 g to about 50 g of particles. A single dose of the plurality of particles may comprise from about 5 g to about 50 g, alternatively from about 10 g to about 45 g, alternatively from about 20 g to about 40 g, alternatively combinations thereof and any whole numbers of grams or ranges of whole numbers of grams within any of the aforementioned ranges. The plurality of particles can be made up of individual particles having different size, shape, and/or mass. The individual particles in a dose can each have a maximum dimension less than about 15 mm. Individual particles in a dose can have a maximum dimension less than about 1 cm.

The plurality of particles can comprise an antioxidant. The antioxidant can help to promote stability of the color and or odor of the particles over time between production and use. The plurality of particles can comprise from about 0.01% to about 1% by weight antioxidant, optionally from about 0.001% to about 2% by weight antioxidant, optionally from about 0.01% to about 0.1% by weight antioxidant. The antioxidant can be butylated hydroxytoluene.

The particles can be formed via batch or continuous rotoforming process. The particles can be hemispherical, compressed hemispherical, or particles having at least one substantially flat or flat surface. The particles can have a flat surface and a curved surface opposite the flat surface. Such particles may have relatively high surface area to mass as compared to spherical particles. The practicality of processing melts can at least partially depend on the viscosity of the melt.

For any of the compositions described herein, it can be desirable for the compositions to have a viscosity from about 1 Pa-s to about 10 Pa-s at 65 C, from about 1 Pa-s to about 5 Pa-s at 65 C, optionally from about 1.5 to about 4, optionally from about 1 Pa-s to about 3 Pa-s, optionally about 2. Such compositions may be conveniently processed on a rotoformer and yield particles having a desired shape.

The viscosity can be controlled, by way of nonlimiting example, by adding a diluent to the composition. The plurality of particles and or individual particles can comprise a diluent. The diluent can be selected from the group of dipropylene glycol, fatty acid, and combinations thereof.

The plurality of particles can comprise individual particles that comprise at least one of the first hydrophobic conditioning compound, the optional second hydrophobic conditioning compound, the cationic polysaccharide, and optional nonhalide salt. The individual particles can comprise one or more of the first hydrophobic conditioning compound, the optional second hydrophobic conditioning compound, the cationic polysaccharide, and optional nonhalide salt. The individual particles can differ from one another in weight fraction of at least one of the first hydrophobic conditioning compound, the optional second hydrophobic conditioning compound, the cationic polysaccharide, and the optional nonhalide salt. The individual particles can differ from one another in weight fraction of one or more of the first hydrophobic conditioning compound, the optional second hydrophobic conditioning compound, the cationic polysaccharide, and the optional nonhalide salt. Providing particles that differ from one another in weight fraction of at least one of the first hydrophobic conditioning compound, the optional second hydrophobic conditioning compound, the cationic polysaccharide, and the optional nonhalide salt can simplify the manufacturer's ability to provide multiple variants of the composition of the plurality of particles.

Optionally, the individual particles can comprise of the first hydrophobic conditioning compound, the optional second hydrophobic conditioning compound, the cationic polysaccharide, and the optional nonhalide salt. The individual particles can each be compositionally the same as one another. Optionally, the individual particles can comprise the same constituents but differ from one another in weight fraction of the constituents. Such an arrangement may be helpful for providing products that differ from one another by the amount of consumer benefit provided. For example, highly active particles and moderately active particles can be blended together to provide a consumer benefit that is intermediate the consumer benefit provided by the highly active particles alone or the moderately active particles alone.

The manufacturer can form up the plurality of particles by blending different weight fractions of the individual particles to arrive at the desired levels of the first hydrophobic conditioning compound and the optional second hydrophobic conditioning compound. For example, the manufacture can make a first set of individual particles that comprise the water soluble carrier and the first hydrophobic conditioning compound and be substantially free from or free from the cationic polysaccharide or some weight fraction of the cationic polysaccharide other than the weight fraction of the cationic polysaccharide in the second set of particles. The manufacturer can also make a second set of individual particles the comprise the water soluble carrier and the cationic polysaccharide and be substantially free from or free from the first hydrophobic conditioning compound or some weight fraction of the first hydrophobic conditioning compound other than the weight fraction of the first hydrophobic conditioning compound in the first set of particles.

The manufacturer can then blend chosen weight fractions of the sets of individual particles to make the plurality of particles having the desired weight fraction of water soluble carrier, first hydrophobic conditioning compound, optional second hydrophobic conditioning compound, cationic polysaccharide, and optional nonhalide salt. The manufacturer can assemble the plurality of particles with the desired weight fraction of the first hydrophobic conditioning compound and optional second hydrophobic conditioning compound to provide for the desired benefit for the composition of the plurality of particles. The desired weight fraction may be chosen on the basis of the level of softness desired, cost of the composition, typical wash conditions within a geography, different needs of different segments of a market, or other factors. This can reduce the number of formulas for which the manufacturer must maintain production expertise and control, the number of formulas the manufacturer must maintain and specify for certain production runs, and reduce the number of production disruptions to provide for variations in the composition of the plurality of particles.

### Process for Forming Particles

The particles can be formed via processes for converting a melt into particles. The particles can be formed by a process selected from the group of spheronizing, spray drying, extrusion, and rotoforming.

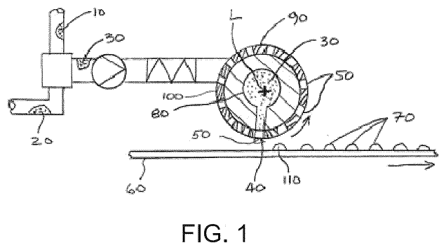

A suitable apparatus for forming particles 70 is shown in FIG. 1. To form the particles 70, a premix 10 comprising the first hydrophobic conditioning compound and the nonionic surfactant can be provided. A melt 20 comprising a water soluble carrier can further be provided. The premix 10 and the melt 20 can be mixed together to form a precursor material 30. The premix 10 and melt 20 can be mixed together in a batch process or continuously mixed with one another.

The apparatus can include a distributor 40 comprising a plurality of apertures 50. A moveable conveyor 60 can be provided beneath the distributor 40. The precursor material 30 can be passed through the apertures 50 and deposited onto a moveable conveyor 60. The precursor material 30 can be deposited on the moveable conveyor 60 in the form a noodle or as a drops 110. If deposited as a noodle, the noodle can be cut and cooled to form the particles. If deposited as drops, the drops of precursor material 30 can be cooled to form the particles 70. The cooling can be by way of ambient cooling or active cooling.

Optionally, the distributor 40 can comprise a stator 80 upstream of the apertures and a cylinder 90 rotationally mounted about the stator 80, the cylinder 90 being rotatable about a longitudinal axis L of the cylinder 90. The cylinder 90 can have a periphery 100 disposed about the longitudinal axis L. The cylinder 90 can comprise the apertures 50 disposed about the periphery 100. The apertures 50 can be intermittently in fluid communication with the stator 80 as the cylinder 90 rotates about the stator 80.

The premix 20 comprising the first hydrophobic conditioning compound and the nonionic surfactant can be formed by a batch process or a continuous process. Similarly, the premix 10 and the melt 20 can be mixed to form the precursor material 30 via a batch process or a continuous process.

Optionally, a gas be entrained in the precursor material 30 upstream of the apertures 50. Entraining a gas into the precursor material 30 can be practical for providing porous particles 70. The amount of gas entrained can be chosen based on the desired density of individual particles 70.

### Examples

### Production of Premixes:

The premixes of nonionic surfactant and hydrophobic conditioning compound were made according to the following method. The desired amount of hydrophobic conditioning compound was added into a glass jar and placed in an oven set to 80° C. until the hydrophobic conditioning compound was fully melted. The nonionic surfactant was also placed in an oven set to 80° C. for about 30 minutes prior to adding the nonionic surfactant into the melted hydrophobic conditioning compound. The desired amount of heated nonionic surfactant was added into the melted hydrophobic conditioning compound and mixed at 450-500 rpm using an overhead mixer having a 4-blade pitch blade turbine shaft (ka RW20 mixer) for about 2 minutes. After 2 minutes of mixing, the premix was placed in an oven set to 80° C. for 30 minutes. After 30 minutes, the premix was removed from the oven and kept at room temperature.

### Viscosity of Premixes:

The viscosity of the conditioning agent and NI surfactant premix composition was measured using a TA instrument HR20 controlled stress rheometer, with a 20 mm Peltier stainless steel parallel plate. Prior to measuring viscosity of the pre-mixes, the instrument inertia and friction were calibrated. In addition, a gap temperature compensation calibration was performed. The viscosity was measured using a flow temperature ramp procedure. The temperature range was set from 25° C. to 60° C. using a temperature ramp of 3° C./min at a shear rate of 1 sec-1 and a soak time of 180 seconds.

### Production of Particles

Particles were prepared by providing a 65:35 weight percent blend of PLURIOL E 8000 Prill Polyethylene Glycol having a weight average molecular weight of 9000 Da and Dow Carbowax Polyethylene Glycol having a weight average molecular weight of 4000 Da respectively in a MAX 100 SPEEDMIX cup and placing the cup of material in an oven having a temperature of 80° C. overnight to melt. The hydrophobic conditioning compound or compounds and/or the premix of hydrophobic conditioning compound and nonionic surfactant, if employed, were placed in an oven at 80° C. for 30 minutes before adding them to the polyethylene glycol blend. The MAX 100 SPEEDMIX cup of polyethylene glycol blend was removed from the oven in the morning before starting the production of particles. The cationic polysaccharide, the hydrophobic conditioning compound or compounds and/or the premix of hydrophobic conditioning compound and nonionic surfactant, if employed, were added to the MAX 100 SPEED MIX cup containing the melted polyethylene glycol blend. The contents of the MAX 100 SPEEDMIX cup were thoroughly mixed by swirling the contents with a spatula and placed immediately into a SPEEDMIXER DAC 150 FVC-K (FLAK TEK Inc.) for 60 seconds at 3500 revolutions per minute. The mixture was then immediately poured onto a rubber mold that was kept in a refrigerator at 4° C. and spread with a spatula into depressions in the rubber mold. The mixture hardened in the depressions of the rubber mold to form the particles. The hardened particles were removed from the rubber mold. The mold shape was an oblate hemisphere having a diameter of 5.0 mm and a height of 2.5. The specimen particles were stored at 23° C. and 50% relative humidity for 5 days before testing for softness performance.

### Process for Treating an Article of Clothing

To assess the softness performance of the particles disclosed herein, fabrics were prepared/treated through the wash sub-cycle according to the following method.

### A. Equipment and Materials

Fabrics were assessed using Kenmore FS 600 and/or 80 series washing machines. Washing machines were set at: 20° C./20° C. wash/rinse temperature, 3 grains per gallon hardness water, normal cycle, and small load (46 liters). Fabric bundles consisted of 2.4 kilograms of clean fabric consisting of 50% cotton and 50% polycotton ballast (9 cotton, 9 polycotton). Test swatches were included with this bundle and comprised of 3-100% cotton (479) and 3-50%/50% polycotton (7422) fabrics ordered from Test Fabrics.

### B. Stripping and Desizing

Prior to treatment with any test products, the fabric bundles were stripped according to the Fabric Preparation-Stripping and Desizing procedure before running the test.

The Fabric Preparation-Stripping and Desizing procedure included washing the fabric bundle (2.7-3.6 Kg of fabric consisting of 50% cotton and 50% polycotton ballast) for 5 consecutive wash cycles, where only the first 2 cycles were done with a liquid detergent in 140° F. (60° C.) soft water. A liquid detergent containing alcohol ethoxysulfates, linear alkylbenzene sulfonate, C12-C16 alcohol ethoxylate AE9, fatty acids, and other minors was used to strip/de-size the test swatch fabrics and fabric bundle. Cycles 3-5 were washed without detergent in 1400 F (60° C.) soft water. After the fifth wash and rinse cycle the fabric bundle was transfer to Kenmore dryers on high setting for 50 minutes. The wash conditions were as follows: TL Kenmore 600 and/or 80 series wash machines (or equivalent), set at: 60° C./60° C. wash/rinse temperature, soft water, heavy duty cycle, and 22 gallon fill. The dryer timer was set for 50 minutes on the cotton/high/timed dry setting.

### C. Test Treatment

Fabrics were treated by adding a dose of 82 g of a Tide perfume free (nil enzyme, nil dye, 1.9% alcohol ethoxysulfates, 10.1% linear alkylbenzene sulfonate, 3.5% sodium lauryl sulfate, 0.3% amine oxide and 10.5% non-ionic surfactants) liquid detergent and 37 g of the specimen particles. The detergent was added under the surface of the water while the machine was filling water into the drum. Once the water stopped flowing and the washer began to agitate, 37 g of the specimen particles was added to the wash liquor. After 5 seconds of agitation the machine was stopped and the clean fabric bundle was added. Then the wash cycle was resumed. When the wash/rinse cycle was complete, each wet fabric bundle was transferred to a corresponding dryer. The dryer used was a Maytag commercial series (or equivalent) electric dryer, with the timer set for 50 minutes on the cotton/high heat/timed dry setting. After the drying cycle was complete, the test fabrics were then placed in a constant temperature/relative humidity (21° C., 50% relative humidity) controlled room for 12 to 24 hours and then evaluated for softness performance.

### Secant Modulus Instron Method

The Secant Modulus was measured using a Tensile and Compression Tester Instrument, Instron Model 5565 (Instron Corp., Norwood, Massachusetts, U.S.A.). The instrument was configured depending on the fabric type by selecting the following settings: the mode was Tensile Extension; the Waveform Shape was Triangle; the Maximum Strain was 10% for 479 and 494 100% Cotton Woven and 35% for 7422 50:50 Polycotton Knitted; the Rate was 0.83 mm/sec for 100% Cotton Woven and 2.5 mm/sec for Polycotton Knitted; the number of Cycles was 4; and the Hold time was 15 seconds between cycles. Fabric swatches were prepared and evaluated as per the following steps.
1. With scissors, cut serged edge of one entire side of each swatch in the warp direction and carefully peel off strings without stressing the fabric until an even edge is achieved.
2. Place a fabric press die that cuts strips 1″ wide and at least 4″ long parallel to the even edge and cut strips lengthwise in the warp direction.
3. Cut 3 strips of 100% Cotton Woven or Polycotton Knitted test fabric from 3 separate fabric swatches per treatment. Condition fabrics in a constant temperature (70° F.) and humidity (50% RH) room for at least 6 hours before analysis.
4. Clamp the top and then the bottom of fabric strip into the 2.54 cm grips on the tensile tester instrument with a 2.54 cm gap setting, loading a small amount of force (0.0.05N-0.2N) on the sample.
5. Release bottom clamp and re-clamp sample during the hold cycle, loading 0.05N-0.2N of force on the sample removing the slack by again loading the same force.
6. When 4 hysteresis cycles have been completed for the sample, the Secant Modulus is calculated at the maximum strain for each fabric type and average across the 9 swatches per treatment. The average secant modulus for the control fabric is subtracted from the average secant modulus of the test fabric specified in each experiment and then reported as Delta Secant Modulus. A positive Delta Secant Modulus indicates that the test fabric has a lower secant modulus than the control fabric. Fabrics that are more lubricated have a lower secant modulus which is perceived as softer than the respective control fabric. A negative Delta Secant Modulus indicates that the test fabric has a higher secant modulus than the control fabric. Fabrics that are less lubricated have a higher secant modulus which is perceived as less soft than the respective control fabric.

### Molecular Weight

Weight-average molecular weight (M_{w}) values were determined as follows. Sample molecular weights were determined on an Agilent 1260 HPLC system equipped with autosampler, column oven, and refractive index detector. The operating system was OpenLAB CDS ChemStation Workstation (A.01.03). Data storage and analysis were performed with Cirrus GPC offline, GPC/SEC Software for ChemStation, version 3.4. Chromatographic conditions are given in Table 1. In carrying out the calculation, the results were calibrated using polystyrene reference samples having known molecular weights. Measurements of M_{w} values vary by 5% or less. The molecular weight analyses were determined using a chloroform mobile phase.

TABLE 1
Chromatographic conditions.

| Parameter | Conditions |
|---|---|
| Column Set | Three ResiPore columns (Agilent #1113-6300) in |
| | series with guard column (Agilent #1113-1300) |
| | Particle size: 3 μm |
| | Column dimensions: 300 × 7.5 mm |
| Mobile Phase | Chloroform |
| Flow Rate | 1 mL/min, needle wash is included |
| Column Temperature | 40° C. |
| Injection Volume | 20 μL |
| Detector | Refractive Index |
| Detector Temperature | 40° C. |

Table 2 lists the molecular weights and the retention times of the polystyrene standards.

TABLE 2
Molecular weights and retention times of the polystyrene standards.

| Standard Number | Average Reported MW Da | Retention Time (min) |
|---|---|---|
| 1 | 150000 | 19.11 |
| 2 | 100000 | 19.63 |
| 3 | 70000 | 20.43 |
| 4 | 50000 | 20.79 |
| 5 | 30000 | 21.76 |
| 6 | 9000 | 23.27 |
| 7 | 5000 | 23.86 |
| 8 | 1000 | 27.20 |
| 9 | 500 | 28.48 |

### Particle/Droplet Size

The volume-weighted mean diameter of the hydrophobic conditioning compound droplets was analyzed utilizing a Horiba Particle Size Distribution Analyzer LA-950V2 with a static quartz cell and operated in accordance with the manufacturer's instructions. Samples were prepared by dissolving 0.2 g of the specimen particles composition in 150 g of deionized water. Within the instrument software: the Iteration Mode was selected as Auto; and the Distribution Base was set as Volume. The refractive index (RI) value of the continuous phase was set as the RI value of water by selecting Water from the instrument software library, which inserts a RI value of 1.33. The RI value of the dispersed phase was set as the RI value of the predominant hydrophobic conditioning agent (by wt %) present in the dispersed phase and was set by selecting that material within the software library. Within the Horiba LA-950V2 software library, e.g., 1.477-0.001(1.33) is the preferred selection for this hydrophobic conditioning agent dispersed in water. With the test sample loaded in the instrument, the values for the Laser T % and Lamp T % light transmittance parameters were assessed via the display in the instrument software. Both of these T % parameters are required to fall within the instrument-specified acceptable ranges (70% to 95%) before measurement data can be collected. The instrument-specified acceptable ranges are viewable from the measurement window of the analysis software. If the test sample T % values are higher than the center third of this range, then the sample is diluted with DI water until the sample registers T % values within the zones specified. If the T % values are below the center third of the ranges, the test sample is remade at a higher wt % concentration such that the T % parameter requirements are satisfied. Each composition being tested was prepared and measured in at least three replicate dispersions of a suitable concentration. Each replicate sample was weighed and dissolved separately. Each replicate sample was measured after performing a rinse step which used that sample preparation as the rinsing liquid. Since a prepared dispersion may not be stable after preparation, all testing of a dispersion was conducted within the 10 min after the stirring period was completed. After each particle size measurement analysis, the instrument software displayed a volume-weighted plot of Frequency (%) versus Diameter (mm), as well as the value of the mean, D10, and D90 volume-weighted particle diameter.

### X-ray Scattering Method:

Small-angle X-ray scattering (“SAXS”) as used to characterize ordered microstructures is essentially an X-ray diffraction technique. The microstructure(s) present in the scattering pattern are characterized by the relative positions (d-spacing) of their reflections as derived from the Bragg equation (d=λ/2 Sin θ) where d represents the interplanar spacing, λ the radiation wavelength and θ the scattering (diffraction) angle. Here, the SAXS (small angle) data was collected with a Xenocs Xeuss 3.0. Its GeniX^{3D} Cu high flux very long focus x-ray tube was operated at 50 kV, 0.60 mA. Its sample to detector distance was set for SAXS collection at 900 mm with an Eiger R 1M Dectris detector. Samples were sealed in capillaries and analyzed under vacuum with a standard beam configuration and a collection time of 1800 s.

Premixes of hydrophobic conditioning compound and nonionic surfactant as listed in Table 3 were prepared.

TABLE 3
Premixes consisting of the listed weight percent of nonionic surfactant,
the balance being hydrophobic conditioning compound¹.

| | WEIGHT % OF NONIONIC | |
|---|---|---|
| | SURFACTANT IN | |
| | HYDROPHOBIC | NONIONIC |
| EXAMPLE | CONDITIONING PREMIX | SURFACTANT |
| CONTROL A | 0 | — |
| EXAMPLE 1 | 42 | LUTENSOL |
| | | XL70² |
| EXAMPLE 2 | 42 | LUTENSOL |
| | | XP30³ |
| EXAMPLE 3 | 42 | LUTENSOL |
| | | XP80⁴ |
| EXAMPLE 4 | 42 | TWEEN 20⁵ |
| EXAMPLE 5 | 42 | TWEEN 80⁶ |
| EXAMPLE 6 | 42 | TWEEN 85⁷ |
| EXAMPLE 7 | 42 | SPAN 80⁸ |
| EXAMPLE 8 | 42 | SPAN 85⁹ |
| EXAMPLE 9 | 42 | SPAN 20¹⁰ |
| EXAMPLE 10 | 42 | NOVEL 810-4.5 |
| | | EO¹¹ |
| EXAMPLE 11 | 42 | TERGITOL 15- |
| | | S-12¹² |
| EXAMPLE 12 | 42 | TERGITOL 15- |
| | | S-5¹³ |
| EXAMPLE 13 | 42 | TERGITOL 15- |
| | | S-3¹⁴ |
| EXAMPLE 14 | 42 | TERGITOL 15- |
| | | S-15¹⁵ |
| EXAMPLE 15 | 42 | TERGITOL 15- |
| | | S-9¹⁶ |
| | | MOLECULAR |
| | HLB | WEIGHT OF |
| | NONIONIC | NONIONIC |
| EXAMPLE | SURFACTANT | SURFACTANT |
| CONTROL A | — | — |
| EXAMPLE 1 | 12.5 | 449 |
| EXAMPLE 2 | 9 | 290 |
| EXAMPLE 3 | 14 | 493 |
| EXAMPLE 4 | 16.7 | 1228 |
| EXAMPLE 5 | 15 | 1310 |
| EXAMPLE 6 | 11 | 1020 |
| EXAMPLE 7 | 4.3 | 429 |
| EXAMPLE 8 | 1.8 | 958 |
| EXAMPLE 9 | 8.6 | 346 |
| EXAMPLE 10 | 11.6 | 343 |
| EXAMPLE 11 | 14.5 | 738 |
| EXAMPLE 12 | 10.5 | 415 |
| EXAMPLE 13 | 8 | 335 |
| EXAMPLE 14 | 15.4 | 870 |
| EXAMPLE 15 | 13.3 | 596 |

¹Branched polyesters as described in U.S. patent application U.S. Pat. No. 10,787,629 and/or U.S. Pat. No. 11,104,866 with an average molecular weight of 5,000 Da.
²LUTENSOL XL70 with CAS # 166736-08-9.
³LUTENSOL XP30 with CAS # 160875-66-1.
⁴LUTENSOL XP80 with CAS# 160875-66-1 from BASF.
⁵TWEEN 20 with CAS # 9005-54-5.
⁶TWEEN 80 with CAS # 9005-65-6.
⁷TWEEN 85 with CAS # 9005-70-3 from Croda International.
⁸SPAN 80 with CAS # 1338-43-8.
⁹SPAN 85 with CAS# 26266-58-0.
¹⁰SPAN 20 with CAS# 1338-39-2 from Croda International.
¹¹NOVEL 810-4.5EO with CAS # 68439-45-2 from Sasol.
¹²TERGITOL 15-S-12.
¹³TERGITOL 15-S-5.
¹⁴TERGITOL 15-S-3.
¹⁵TERGITOL 15-S-15.
¹⁶TERGITOL 15-S-9 with CAS# 84133-50-6 from Dow Chemicals.

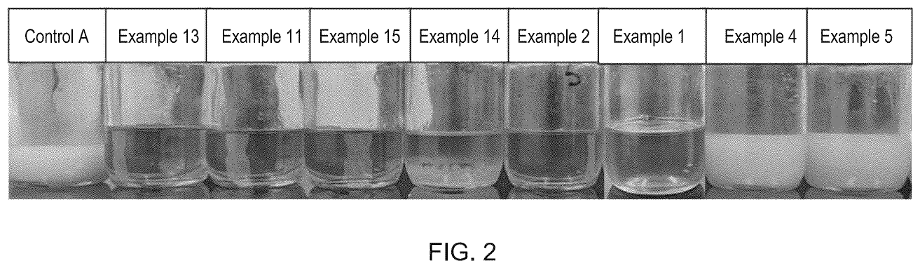

The premixes set forth in Table 3 were stored for eighteen hours at room temperature. Premixes consisting of a nonionic surfactant having a HLB between 8 and 15 and a molecular weight below 1,000 Da remained clear after stored for 18 hours at room temperature. The premixes having a nonionic surfactant having a HLB outside this range crystallized back over time as shown by Examples 4 and 5 same as Control A (FIG. 2).

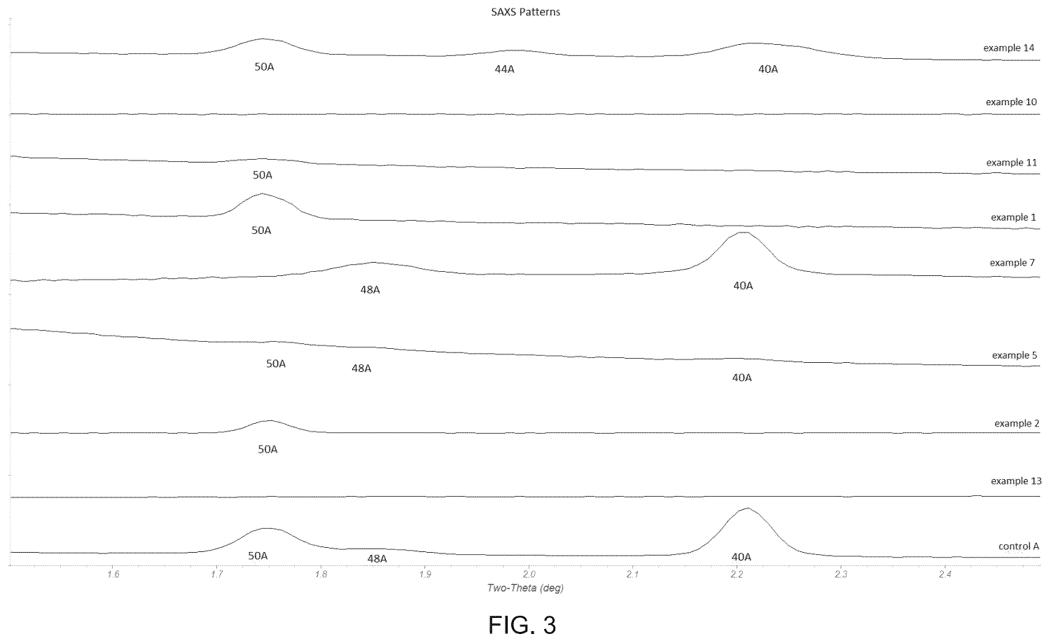

Results of SAXS analyses for evaluating crystallization of the hydrophobic conditioning compound for the exemplary are listed in Table 4. The SAXS scattering patterns are shown in FIG. 3. As shown in FIG. 3, Control A exhibits a distinctive SAXS peak between 50 Å and 40 Å that is believed to occur because of the crystallization of stearic acid and 12-hydroxy stearic acid impurities in the sample from the synthesis process. There is a decrease in the intensity of the distinctive peak when surfactants having an HLB between 8 and 15 and a molecular weight below 1,000 Da are premixed with the hydrophobic conditioning compound as shown in Examples 1, 2, 10, 11, and 13. For premixes employing nonionic surfactants having a HLB outside 8 to 15, only a small decrease in the SAXS peak between 50 Å to 40 Å was observed. The presence of larger structures outside the SAXS range of 50 Å to 40 Å, as shown in FIG. 2, Examples 5, 7, and 14, limited the ability to fully characterize peak heights within the 50 Å to 40 Å range.

TABLE 4
Peak height of SAXS scattering patterns for examples listed in Table 1 consisting
of premixes of the listed nonionic surfactants and the hydrophobic conditioning
agent¹. The peak height of Examples 5 and 14 were not measured (NM) due to likely
presence of large structures outside the SAXS range impacting the measurement.

| | GAUSSIAN | GAUSSIAN | GAUSSIAN | GAUSSIAN | |
|---|---|---|---|---|---|
| | HEIGHT AT | HEIGHT AT | HEIGHT AT | HEIGHT AT | |
| EXAMPLE | (~50 Å) | (~48 Å) | (~44 Å) | (~40 Å) | LAMELLAR |
| CONTROL A | 0.028 | 0.0057 | — | 0.054 | additional |
| | | | | | structure |
| | | | | | at ~185 Å |
| EXAMPLE 1 | 0.013 | — | — | — | — |
| EXAMPLE 2 | 0.014 | — | — | — | — |
| EXAMPLE 3 | 0.019 | — | — | — | — |
| EXAMPLE 5 | NM | NM | — | 0.0042 | scattering |
| | | | | | outside the |
| | | | | | SAXS |
| | | | | | indicative of |
| | | | | | likely large |
| | | | | | lamellar |
| | | | | | particles |
| EXAMPLE 7 | — | 0.013 | — | 0.046 | — |
| EXAMPLE 10 | — | — | — | — | — |
| EXAMPLE 11 | 0.003 | — | — | — | — |
| EXAMPLE 13 | — | — | — | — | — |
| EXAMPLE 14 | 0.017 | — | NM | 0.016 | additional |
| | | | | | structure |
| | | | | | at ~80 Å |

¹Branched polyesters as described in U.S. patent application U.S. Pat. No. 10,787,629 and/or U.S. Pat. No. 11,104,866 with an average molecular weight of 5,000 Da.

The viscosity of each of the compositions listed in Table 3 was measured and results are reported in Table 5. The viscosity of the premixes made with a nonionic surfactant having a HLB between 8 and 15 and having a molecular weight below 1,000 Da decreased by more than 80% relative to the viscosity of the hydrophobic conditioning compound of interest in a temperature range between 35° C. to 55° C. as exemplified by Examples 1-3, 10, 11, and 13 in Table 5. This is not the case for premixes made with nonionic surfactants outside this range as exemplified by Examples 5, 7, and 14. This is believed to be caused by a reduction in the crystallinity of the impurities present in the hydrophobic conditioning compound which causes the compound to become highly viscous at room temperature and therefore requiring high energy and temperature to process.

TABLE 5
Reduction in viscosity and mean drop size of examples listed
in Table 1 consisting of premixes of the listed nonionic surfactants
and the hydrophobic conditioning agent¹.

| EXAMPLE | 40° C. | 45° C. | 50° C. |
|---|---|---|---|
| CONTROL A | 4.58 Pa · s | 1.95 Pa · s | 1.13 Pa · s |
| EXAMPLE 1 | 86% | 82% | 81% |
| EXAMPLE 2 | 96% | 96% | 95% |
| EXAMPLE 3 | 83% | 82% | 81% |
| EXAMPLE 5 | 51% | 45% | 45% |
| EXAMPLE 7 | 70% | 66% | 65% |
| EXAMPLE 10 | 91% | 89% | 88% |
| EXAMPLE 11 | 84% | 82% | 80% |
| EXAMPLE 13 | 91% | 90% | 88% |
| EXAMPLE 14 | 51% | 45% | 38% |

¹Branched polyesters as described in U.S. patent application U.S. Pat. No. 10,787,629 and/or U.S. Pat. No. 11,104,866 with an average molecular weight of 5,000 Da.

The drop size of the hydrophobic conditioning agent dispersed in water was also evaluated for several of the above example premixes and are reported in Table 6. Premixes that employed a nonionic surfactant having a HLB between 8 and 15 and a molecular weight below 1,000 Da (Examples 1, 10, and 11) tended to have a smaller drop size compared to premixes not having a nonionic surfactant meeting these criteria (Examples 4, 5, and 7).

TABLE 6
Drop size of hydrophobic conditioning compound¹ premix
with nonionic surfactant as listed in Table 3. The hydrophobic
conditioning compound¹ is not dispersible (ND) in water
when added directly in water (CONTROL A).

| | MEAN DROP | D10 DROP | D90 DROP |
|---|---|---|---|
| EXAMPLE | SIZE (μm) | SIZE (μm) | SIZE (μm) |
| CONTROL A | ND | ND | ND |
| EXAMPLE 1 | <1 | <1 | <1 |
| EXAMPLE 4 | 23 | 2 | 41 |
| EXAMPLE 5 | 8 | <1 | 13 |
| EXAMPLE 7 | 42 | 3 | 132 |
| EXAMPLE 10 | <1 | <1 | <1 |
| EXAMPLE 12 | <1 | <1 | <1 |

¹Branched polyesters as described in U.S. patent application U.S. Pat. No. 10,787,629 and/or U.S. Pat. No. 11,104,866 with an average molecular weight of 5,000 Da.

To evaluate the impact of the premixes listed in Table 3 on delivering fabric softening benefits, specimens of particles listed in Table 7 were prepared in accordance with the method of making provided in the Production of Particles above. Fabrics were treated with the specimen particles and tumble dried in accordance with the process of treating a clothing article provided in the specification. After the wash process was completed, the fabrics were equilibrated in a controlled temperature and humidity room (21° C./50% relative humidity) overnight before evaluation. After fabrics were equilibrated, the secant modulus of the test fabrics was evaluated in accordance with the test method provided in the specification, as reported in Table 8. Controlling the crystallization of the hydrophobic conditioning by premixing with a nonionic surfactant having a HLB between 8 and 15 and a molecular weight below 1,000 Da show superior softness benefits on fabrics treated with particles comprising these premixes (Examples 16, 17, and 19) versus particles comprising premixes with nonionic surfactants outside this range (Example 18).

TABLE 7
Particles consisting of the listed weight percent of hydrophobic
conditioning agents, cationic polysaccharide, nonionic surfactant,
and balance of polyethylene glycol blend on test fabrics.

| | WEIGHT % OF | WEIGHT % OF | WEIGHT % OF |
|---|---|---|---|
| | HYDROPHOBIC | HYDROPHOBIC | CATIONIC |
| | CONDITIONING | CONDITIONING | POLY- |
| EXAMPLE | COMPOUND¹ | COMPOUND² | SACHARIDE³ |
| CONTROL A | 12.5 | — | 3.5 |
| CONTROL B | 12.5 | 8 | 3.5 |
| EXAMPLE 16 | 12.5 | — | 3.5 |
| EXAMPLE 17 | 12.5 | — | 3.5 |
| EXAMPLE 18 | 12.5 | — | 3.5 |
| EXAMPLE 19 | 12.5 | 8 | 3.5 |

| | WEIGHT % OF | |
|---|---|---|
| | NONIONIC | NONIONIC |
| EXAMPLE | SURFACTANT | SURFACTANT |
| CONTROL A | — | — |
| CONTROL B | — | — |
| EXAMPLE 16 | 9 | LUTENSOL XL70 |
| EXAMPLE 17 | 5 | TERGITOL 15-S-12 |
| EXAMPLE 18 | 9 | TWEEN 80 |
| EXAMPLE 19 | 9 | NOVEL 810-4.5EO |

¹Branched polyesters as described in U.S. patent application U.S. Pat. No. 10,787,629 and/or U.S. Pat. No. 11,104,866 with an average molecular weight of 5,000 Da.
²Amino-functional organosiloxane as described in Examples 1 to 4 of U.S. patent application U.S. Pat. No. 8,940,284 with an average molecular weight of 30,000 Da.
³Cationic hydroxyethyl cellulose having a weight average molecular weight of 400 kDa, a charge density of 0.18, and an average weight percent of nitrogen per anydroglucose repeat unit of 0.28% (Polymer PK available from Dow Chemical).

TABLE 8
Softness benefits provided by particles in Table 7.

| | | DELTA SECANT |
|---|---|---|
| | SECANT MODULUS | MODULUS VS. |
| | CONTROL (479 | CONTROL (479 |
| EXAMPLE | 100% WOVEN) | 100% WOVEN) |
| CONTROL A | 210 MPa | Ref. |
| EXAMPLE 16 | — | +9 |
| CONTROL A | 193 MPa | Ref. |
| EXAMPLE 17 | — | +10 |
| CONTROL A | 204 MPa | Ref. |
| EXAMPLE 18 | — | +6 |
| CONTROL B | 204 MPa | Ref. |
| EXAMPLE 19 | — | +12 |

### Combinations

An Example follows:

A. A composition comprising a plurality of particles, said plurality of particles comprising: about 25% to about 93% by weight a water soluble carrier;
about 5% to about 45% by weight a first hydrophobic conditioning compound having a weight average molecular weight greater than 1000 Da;
about 0.5% to about 10% by weight a cationic polysaccharide; and
about 0.5% to about 20% by weight a nonionic surfactant;
wherein individual particles of said plurality of particles have a mass from about 1 mg to about 1 g.
   B. The composition according to Paragraph A, wherein said first hydrophobic conditioning compound comprises a branched polyester selected from the group of:
a) a branched polyester having Formula 1

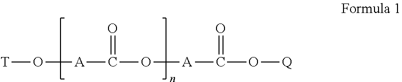

wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
b) a branched polyester having Formula 2

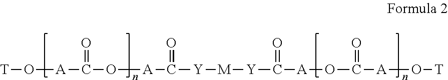

wherein:
each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group of oxygen and NR₂, wherein each R₂ is independently selected from the group of hydrogen, or a C1-C8 alkyl; and
M is a polyalkylene glycol group;
c) a branched polyester having Formula 3

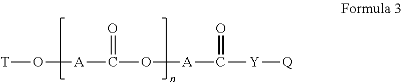

wherein:
   the index n is an integer from 1 to about 100;
   T is a hydrogen or —C(O)—R₁ where in R₁ is an alkyl chain comprising from 7 to 21 carbon atoms;
   each A is independently a branched hydrocarbon chain comprising from 4 to 40 carbon atoms;
   Y is selected from the group of oxygen and NR₂, wherein each R₂ is independently selected from the group of hydrogen, or a C₁-C₅ alkyl;
   Q is selected from the group of:
   i) -B,
   ii) Z-X-Z-W, and
   iii) -V-U-Z-X-Z-W;
wherein
   B is a substituted C₁-C₂₄ alkyl group;
   each Z is independently a substituted or unsubstituted divalent C₂-C₄₀ alkylene radical;
   X is polysiloxane moiety;
   W is selected from the group of —OR₄,

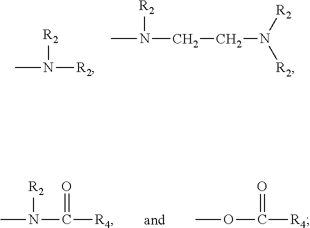

each R₂ is independently selected from the group of hydrogen or a C₁-C₈ alkyl;
R₄ is selected from a hydrogen atom, a C₁-C₂₄ alkyl group or a substituted C₁-C₂₄ alkyl group;
V is a C₁-C₂₄ divalent alkylene radical or a substituted C₁-C₂₄ divalent alkylene;
   U is —C(O)O— or —C(O)NH—; and
d) a branched polyester having Formula 4

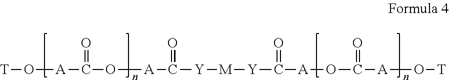

wherein:
   each index n is independently an integer from 1 to about 100; T is a hydrogen atom or —C(O)—R₁ where in R₁ is an alkyl chain comprising from 7 to 21 carbon atoms;
   each A is independently a branched hydrocarbon chain comprising from 4 to 40 carbon atoms;
   each Y is independently selected from the group of oxygen and NR₂, wherein each R₂ is independently selected from the group of hydrogen or a C₁-C₈ alkyl;
   M is selected from the group of:
   i) a C₁-C₂₄ divalent linear or branched alkylene radical;
   ii) -Z-X-Z, and
   iii) --(D--U Z-X-Z--U)ₘ-D-
      wherein:
      m is an integer from 1 to about 10;
      each Z is independently a substituted or unsubstituted divalent C₂-C₄₀ alkylene radical;
      X is polysiloxane moiety;
      U is —C(O)O— or —C(O)NH—; and
      each D is independently a C₁-C₂₄ divalent linear or branched alkylene radical;
e) and mixtures thereof.
   C. The composition according to Paragraph B, wherein said nonionic surfactant has a HLB from 8 to 15.
   D. The composition according to Paragraph B or C, wherein said nonionic surfactant has a molecular weight less than 1000 Da.
   E. The composition according to any of Paragraphs A to D, wherein said plurality of particles comprises individual particles that comprise said water soluble carrier, said first hydrophobic conditioning compound, and said nonionic surfactant.
   F. The composition according to Paragraph A, wherein said first hydrophobic conditioning compound comprises silicone.
   G. The composition according to any of Paragraphs A to F, wherein said plurality of particles further comprises a second hydrophobic conditioning compound having a weight average molecular weight greater than 1000 Da, optionally wherein said first hydrophobic conditioning compound and said second hydrophobic conditioning compound together constitute from about 6% to about 45% by weight of said composition.
   H. The composition according to Paragraph G, wherein said first hydrophobic conditioning compound comprises a branched polyester selected from the group of:
a) a branched polyester having Formula 1

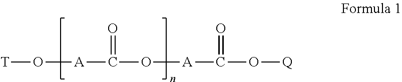

wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
b) a branched polyester having Formula 2

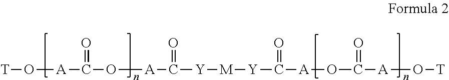

wherein:
each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group of oxygen and NR₂, wherein each R₂ is independently selected from the group of hydrogen, or a C₁-C₈ alkyl; and
M is a polyalkylene glycol group;
c) a branched polyester having Formula 3

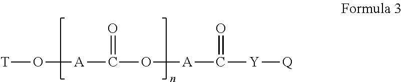

wherein:
   the index n is an integer from 1 to about 100;
   is a hydrogen or —C(O)—R₁ where in R₁ is an alkyl chain comprising from 7 to 21 carbon atoms;
   each A is independently a branched hydrocarbon chain comprising from 4 to 40 carbon atoms;
   Y is selected from the group of oxygen and NR₂, wherein each
   R₂ is independently selected from the group of hydrogen, or a C₁-C₈ alkyl;
   Q is selected from the group of:
   i) -B,
   ii) Z-X-Z-W, and
   iii) V-U-Z-X-Z-W
wherein
   B is a substituted C₁-C₂₄ alkyl group;
   each Z is independently a substituted or unsubstituted divalent C₂-C₄₀ alkylene radical;
   X is polysiloxane moiety;
   W is selected from the group of —OR₄,

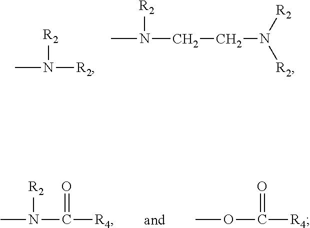

each R₂ is independently selected from the group of hydrogen or a C₁-C₈ alkyl;
R₄ is selected from a hydrogen atom, a C₁-C₂₄ alkyl group or a substituted C₁-C₂₄ alkyl group;
V is a C₁-C₂₄ divalent alkylene radical or a substituted C₁-C₂₄ divalent alkylene;
   U is —C(O)O— or —C(O)NH—; and
d) a branched polyester having Formula 4

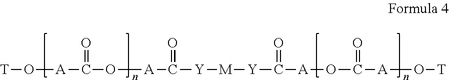

wherein:
   each index n is independently an integer from 1 to about 100; T is a hydrogen atom or —C(O)—R₁ where in R₁ is an alkyl chain comprising from 7 to 21 carbon atoms;
   each A is independently a branched hydrocarbon chain comprising from 4 to 40 carbon atoms;
   each Y is independently selected from the group of oxygen and NR₂, wherein each R₂ is independently selected from the group of hydrogen or a C₁-C₈ alkyl;
   M is selected from the group of:
   i) a C₁-C₂₄ divalent linear or branched alkylene radical,
   ii) -Z-X-Z, and
   iii) --(D--U-Z-X-Z--U)ₘ-D-
      wherein:
      m is an integer from 1 to about 10;
      each Z is independently a substituted or unsubstituted divalent C₂-C₄₀ alkylene radical;
      X is polysiloxane moiety;
      U is —C(O)O— or —C(O)NH—; and
      each D is independently a C₁-C₂₄ divalent linear or branched alkylene radical;
e) and mixtures thereof.
   I. The composition according to Paragraph H, wherein said nonionic surfactant has a HLB from 8 to 15 and a molecular weight less than 1000 Da.
   J. The composition according to any of Paragraphs G to I, wherein said second hydrophobic conditioning compound comprises silicone.
   K. The composition according to any of Paragraphs G to J, wherein said plurality of particles comprises: individual particles that comprise at least one of said first hydrophobic conditioning compound, said second hydrophobic conditioning compound, said cationic polysaccharide, and said nonionic surfactant;
and wherein said individual particles differ from one another in weight fraction of at least one of said first hydrophobic conditioning compound, said second hydrophobic conditioning compound, said cationic polysaccharide, and said nonionic surfactant.
   L. The composition according to any of Paragraphs G to K, wherein individual particles of said plurality of particles comprise said water soluble carrier, said first hydrophobic conditioning compound, said second hydrophobic conditioning compound, said nonionic surfactant, and optionally said cationic polysaccharide.
   M. The composition according to any of Paragraphs G to L, wherein said first hydrophobic conditioning compound and said nonionic surfactant are dispersed in said water soluble carrier.
   N. The composition according to any of Paragraphs G to M, wherein said second hydrophobic conditioning compound is dispersed in said water soluble carrier.
   O. The composition according to any of Paragraphs G to L, wherein said first hydrophobic conditioning compound, said second hydrophobic conditioning compound, and said nonionic surfactant are dispersed in said water soluble carrier.
   P. The composition according to any of Paragraphs B to E or H to O, wherein for said Formula 1:
each A is independently a branched hydrocarbon chain comprising from 4 to 40 carbon atoms;
Q is selected from an alkyl chain comprising 1 to 30 carbon atoms and a hydrogen atom;
T is a hydrogen atom or a —C(O)—R wherein each R is an alkyl chain comprising from 7 to 21 carbon atoms; and
n is an integer from 4 to 40;
wherein for said Formula 2:
   n is an integer from 4 to 40; each A is independently a branched hydrocarbon chain comprising from 4 to 40 carbon atoms;
   each T is independently a hydrogen atom or a —C(O)—R wherein each R is an alkyl chain comprising from 7 to 21 carbon atoms;
   each Y is independently a linking group selected from the group of oxygen and NR₂, wherein each R₂ is independently selected from the group of hydrogen, or a C₁-C₈ alkyl;
   M is a polyalkylene glycol group having a structure of

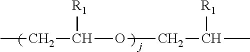

wherein:
each R₁ is selected from hydrogen, methyl and ethyl; and
j is an integer from 0 to about 400.
   Q. The composition according to any of Paragraphs B to E or H to P, wherein said branched polyester polymer having Formula 1 and said branched polyester having Formula 2 each have a weight average molecular weight of from about 1000 Da to about 100000 Da.
   R. The composition according to any of Paragraphs B to E or H to Q, wherein each A of said branched polyester polymers is independently a branched hydrocarbon having the structure

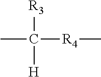

wherein each R₃ is a monovalent alkyl or substituted alkyl group and R₄ is an unsaturated or saturated divalent alkylene radical comprising from 1 to about 24 carbon atoms.
   S. The composition according to any of Paragraphs B to E or H to Q, wherein each A of said branched polyester polymers has the structure

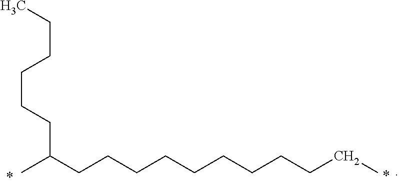 [SMILES: CCCCCCCCCCCC(C)CCCCCC]

T. The composition according to any of Paragraphs A to S, wherein said cationic polysaccharide is cationic hydroxyethylcellulose.
U. The composition according to any of Paragraphs A to T, wherein said water soluble carrier is selected from the group of polyethylene glycol, polypropylene glycol polyoxoalkylene, polyethylene glycol fatty acid ester, polyethylene glycol ether, nonionic starch, and combinations thereof.
V. The composition according to any of Paragraphs A to T, wherein said water soluble carrier is polyethylene glycol having a weight average molecular weight from about 3500 to about 15000 Da.
W. The composition according to any of Paragraphs A to V, wherein said plurality of particles comprises from about 1% to about 5% by weight said cationic polyssacharide.
X. The composition according to any of Paragraphs A to W, wherein said cationic polysaccharide is polymeric quaternary ammonium salt of hydroxyethylcellulose which has been reacted with an epoxide substituted with a trimethylammonium group.
Y. A process for treating an article of clothing comprising the steps of:
providing an article of clothing in a washing machine; and
contacting said article of clothing during a wash sub-cycle of said washing machine with said composition according to any of Paragraphs A to X.
   Z. A process for forming the composition according to any of Paragraphs A to X comprising steps of:
providing a premix (10) comprising said first hydrophobic conditioning compound and said nonionic surfactant;
providing a melt (20) comprising said water soluble carrier;
mixing said premix and said melt together to form a precursor material (30); providing a distributor (40) comprising a plurality of apertures (50);
passing said precursor material through said apertures;
providing a moveable conveyor (60) beneath said apertures;
depositing said precursor material onto said moveable conveyor; and
cooling said precursor material to form said plurality of particles (70).
   AA. The process according to Paragraph Z, wherein said premix comprising said first hydrophobic conditioning compound and said nonionic surfactant is formed by a batch process or a continuous process.
   BB. The process according to Paragraph Z or AA, wherein said distributor comprises a stator (80) upstream of said apertures and a cylinder (90) rotationally mounted about said stator and rotatable about a longitudinal axis (L) of said cylinder, wherein said cylinder has a periphery (100) extending around said longitudinal axis and said cylinder comprises said apertures disposed about said periphery, wherein said apertures are intermittently in fluid communication with said stator as said cylinder rotates about said stator.
   CC. The process according to any of Paragraphs Z to BB, wherein drops (110) of said precursor material are deposited onto said moveable conveyor.
   DD. The process according to any of Paragraphs Z to CC, wherein said premix comprises: from about 20% to about 98% by weight of said premix said first hydrophobic conditioning compound; and from about 2% to about 80% by weight of said premix said nonionic surfactant.
   EE. The process according to any of Paragraphs Z to DD, wherein said premix comprises: from about 50% to about 70% by weight said first hydrophobic conditioning compound; and from about 30% to about 50% by weight said nonionic surfactant. Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed:

1. A composition comprising a plurality of particles, said plurality of particles comprising:
about 25% to about 93% by weight a water soluble carrier;
about 5% to about 45% by weight a first hydrophobic conditioning compound having a weight average molecular weight greater than 1000 Da;
about 0.5% to about 10% by weight a cationic polysaccharide; and
about 0.5% to about 20% by weight a nonionic surfactant;
wherein individual particles of said plurality of particles have a mass from about 1 mg to about 1 g.

2. The composition according to claim 1, wherein said first hydrophobic conditioning compound comprises a branched polyester selected from the group of:
a) a branched polyester having Formula 1 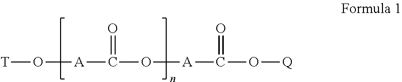
wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
b) a branched polyester having Formula 2 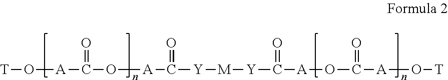
wherein:
each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group of oxygen and NR₂, wherein each R₂ is independently selected from the group of hydrogen, or a C₁-C₈ alkyl; and
M is a polyalkylene glycol group;
c) a branched polyester having Formula 3 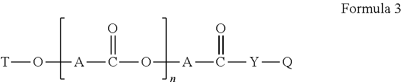
wherein:
the index n is an integer from 1 to about 100;
T is a hydrogen or —C(O)—R₁ where in R₁ is an alkyl chain comprising from 7 to 21 carbon atoms;
each A is independently a branched hydrocarbon chain comprising from 4 to 40 carbon atoms;
Y is selected from the group of oxygen and NR₂, wherein each R₂ is independently selected from the group of hydrogen, or a C₁-C₅ alkyl;
Q is selected from the group of:
i) -B,
ii) Z-X-Z-W, and
iii) V-U-Z-X-Z-W;
wherein
B is a substituted C₁-C₂₄ alkyl group;
each Z is independently a substituted or unsubstituted divalent C₂-C₄₀ alkylene radical;
X is polysiloxane moiety;
W is selected from the group of —OR₄, 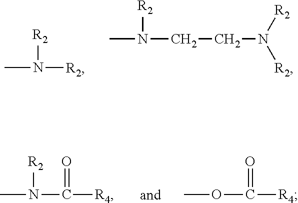
each R₂ is independently selected from the group of hydrogen or a C₁-C₈ alkyl;
R₄ is selected from a hydrogen atom, a C₁-C₂₄ alkyl group or a substituted C₁-C₂₄ alkyl group;
V is a C₁-C₂₄ divalent alkylene radical or a substituted C₁-C₂₄ divalent alkylene;
U is —C(O)O— or —C(O)NH—; and
d) a branched polyester having Formula 4 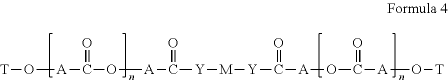
wherein:
each index n is independently an integer from 1 to about 100;
T is a hydrogen atom or —C(O)—R₁ where in R₁ is an alkyl chain comprising from 7 to 21 carbon atoms;
each A is independently a branched hydrocarbon chain comprising from 4 to 40 carbon atoms;
each Y is independently selected from the group of oxygen and NR₂, wherein each R₂ is independently selected from the group of hydrogen or a C₁-C₈ alkyl;
M is selected from the group of:
i) a C₁-C₂₄ divalent linear or branched alkylene radical;
ii) Z-X-Z, and
iii) --(D-U-Z-X-Z-U)ₘ-D-
wherein:
m is an integer from 1 to about 10;
each Z is independently a substituted or unsubstituted divalent C₂-C₄₀ alkylene radical;
X is polysiloxane moiety;
U is —C(O)O— or —C(O)NH—; and
each D is independently a C₁-C₂₄ divalent linear or branched alkylene radical;
e) and mixtures thereof.

3. The composition according to claim 2, wherein said nonionic surfactant has a HLB from 8 to 15.

4. The composition according to claim 3, wherein said nonionic surfactant has a molecular weight less than 1000 Da.

5. The composition according to claim 4, wherein said plurality of particles comprises individual particles that comprise said water soluble carrier, said first hydrophobic conditioning compound, and said nonionic surfactant.

6. The composition according to claim 1, wherein said first hydrophobic conditioning compound comprises silicone.

7. The composition according to claim 1, wherein said plurality of particles further comprises a second hydrophobic conditioning compound having a weight average molecular weight greater than 1000 Da.

8. The composition according to claim 7, wherein said first hydrophobic conditioning compound comprises a branched polyester selected from the group of:
a) a branched polyester having Formula 1 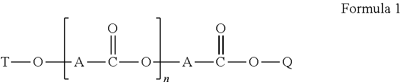
wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
b) a branched polyester having Formula 2 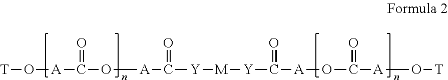
wherein:
each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group of oxygen and NR₂, wherein each R₂ is independently selected from the group of hydrogen, or a C₁-C₈ alkyl; and
M is a polyalkylene glycol group;
c) a branched polyester having Formula 3 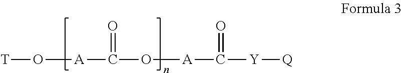
wherein:
the index n is an integer from 1 to about 100;
is a hydrogen or —C(O)—R₁ where in R₁ is an alkyl chain comprising from 7 to 21 carbon atoms;
each A is independently a branched hydrocarbon chain comprising from 4 to 40 carbon atoms;
Y is selected from the group of oxygen and NR₂, wherein each R₂ is independently selected from the group of hydrogen, or a C₁-C₈ alkyl;
Q is selected from the group of:
i) -B,
ii) Z-X-Z-W, and
iii) V-U-Z-X-Z-W
wherein
B is a substituted C₁-C₂₄ alkyl group;
each Z is independently a substituted or unsubstituted divalent C₂-C₄₀ alkylene radical;
X is polysiloxane moiety;
W is selected from the group of —OR₄, 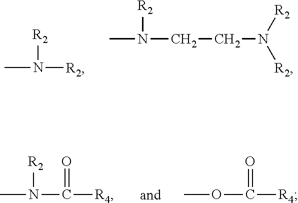
each R₂ is independently selected from the group of hydrogen or a C₁-C₈ alkyl;
R₄ is selected from a hydrogen atom, a C₁-C₂₄ alkyl group or a substituted C₁-C₂₄ alkyl group;
V is a C₁-C₂₄ divalent alkylene radical or a substituted C₁-C₂₄ divalent alkylene;
U is —C(O)O— or —C(O)NH—; and
d) a branched polyester having Formula 4 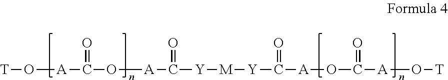
wherein:
each index n is independently an integer from 1 to about 100;
T is a hydrogen atom or —C(O)—R₁ where in R₁ is an alkyl chain comprising from 7 to 21 carbon atoms;
each A is independently a branched hydrocarbon chain comprising from 4 to 40 carbon atoms;
each Y is independently selected from the group of oxygen and NR₂, wherein each R₂ is independently selected from the group of hydrogen or a C₁-C₈ alkyl;
M is selected from the group of:
i) a C₁-C₂₄ divalent linear or branched alkylene radical,
ii) -Z-X-Z-, and
iii) --(D-U-Z-X-Z-U)ₘ-D-
wherein:
m is an integer from 1 to about 10;
each Z is independently a substituted or unsubstituted divalent C₂-C₄₀ alkylene radical;
X is polysiloxane moiety;
U is —C(O)O— or —C(O)NH—; and
each D is independently a C₁-C₂₄ divalent linear or branched alkylene radical;
e) and mixtures thereof.

9. The composition according to claim 8, wherein said nonionic surfactant has a HLB from 8 to 15 and a molecular weight less than 1000 Da.

10. The composition according to claim 9, wherein said second hydrophobic conditioning compound comprises silicone.

11. The composition according to claim 10, wherein individual particles of said plurality of particles comprise said water soluble carrier, said first hydrophobic conditioning compound, said second hydrophobic conditioning compound, and said nonionic surfactant.

12. The composition according to claim 10 wherein individual particles of said plurality of particles comprise said first hydrophobic conditioning compound and said nonionic surfactant are dispersed in said water soluble carrier.

13. The composition according to claim 10, wherein for said Formula 1:
each A is independently a branched hydrocarbon chain comprising from 4 to 40 carbon atoms;
Q is selected from an alkyl chain comprising 1 to 30 carbon atoms and a hydrogen atom;
T is a hydrogen atom or a —C(O)—R wherein each R is an alkyl chain comprising from 7 to 21 carbon atoms; and
n is an integer from 4 to 40;
wherein for said Formula 2:
n is an integer from 4 to 40;
each A is independently a branched hydrocarbon chain comprising from 4 to 40 carbon atoms;
each T is independently a hydrogen atom or a —C(O)—R wherein each R is an alkyl chain comprising from 7 to 21 carbon atoms;
each Y is independently a linking group selected from the group of oxygen and NR₂,
wherein each R₂ is independently selected from the group of hydrogen, or a C₁-C₈ alkyl;
M is a polyalkylene glycol group having a structure of 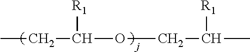
wherein:
each R₁ is selected from hydrogen, methyl and ethyl; and
j is an integer from 0 to about 400.

14. The composition according to claim 10, wherein said branched polyester polymer having Formula 1 and said branched polyester having Formula 2 each have a weight average molecular weight of from about 500 Da to about 100000 Da.

15. The composition according to claim 10, wherein each A of said branched polyester polymers is independently a branched hydrocarbon having the structure 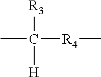
wherein each R₃ is a monovalent alkyl or substituted alkyl group and R₄ is an unsaturated or saturated divalent alkylene radical comprising from 1 to about 24 carbon atoms.

16. The composition according to claim 10, wherein each A of said branched polyester polymers has the structure:

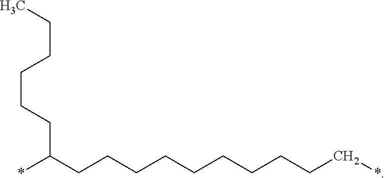

17. The composition according to claim 10, wherein the branched polyester polymer has an iodine value from about 0 to about 90.

18. The composition according to claim 10, wherein said water soluble carrier is selected from the group of polyethylene glycol, polypropylene glycol polyoxoalkylene, polyethylene glycol fatty acid ester, polyethylene glycol ether, nonionic starch, and combinations thereof.

19. A process for treating an article of clothing comprising the steps of:
providing an article of clothing in a washing machine; and
contacting said article of clothing during a wash sub-cycle of said washing machine with a composition according to claim 10.

20. A process for forming a composition comprising steps of:
providing a premix comprising a first hydrophobic conditioning compound and a nonionic surfactant;
providing a melt comprising a water soluble carrier;
mixing said premix and said melt together to form a precursor material;
providing a distributor comprising a plurality of apertures;
passing said precursor material through said apertures;
providing a moveable conveyor beneath said apertures;
depositing said precursor material onto said moveable conveyor; and
cooling said precursor material to form said plurality of particles;
wherein said first hydrophobic conditioning compound comprises a branched polyester selected from the group of:
a) a branched polyester having Formula 1 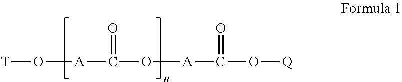
wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
b) a branched polyester having Formula 2 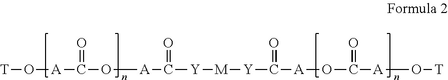
wherein:
each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group of oxygen and NR₂, wherein each R₂ is independently selected from the group of hydrogen, or a C₁-C₈ alkyl; and
M is a polyalkylene glycol group;
c) a branched polyester having Formula 3 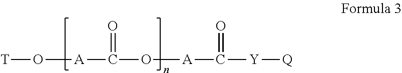
wherein:
the index n is an integer from 1 to about 100;
T is a hydrogen or —C(O)—R₁ where in R₁ is an alkyl chain comprising from 7 to 21 carbon atoms;
each A is independently a branched hydrocarbon chain comprising from 4 to 40 carbon atoms;
Y is selected from the group of oxygen and NR₂, wherein each R₂ is independently selected from the group of hydrogen, or a C₁-C₅ alkyl;
Q is selected from the group of:
i) -B,
ii) Z-X-Z-W, and
iii) V-U-Z-X-Z-W;
wherein
B is a substituted C₁-C₂₄ alkyl group;
each Z is independently a substituted or unsubstituted divalent C₂-C₄₀ alkylene radical;
X is polysiloxane moiety;
W is selected from the group of —OR₄, 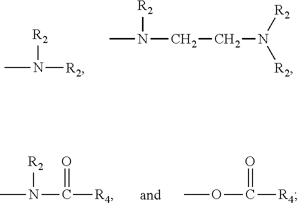
each R₂ is independently selected from the group of hydrogen or a C₁-C₈ alkyl;
R₄ is selected from a hydrogen atom, a C₁-C₂₄ alkyl group or a substituted C₁-C₂₄ alkyl group;
V is a C₁-C₂₄ divalent alkylene radical or a substituted C₁-C₂₄ divalent alkylene;
U is —C(O)O— or —C(O)NH—; and
d) a branched polyester having Formula 4 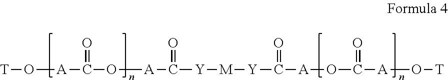
wherein:
each index n is independently an integer from 1 to about 100;
T is a hydrogen atom or —C(O)—R₁ where in R₁ is an alkyl chain comprising from 7 to 21 carbon atoms;
each A is independently a branched hydrocarbon chain comprising from 4 to 40 carbon atoms;
each Y is independently selected from the group of oxygen and NR₂, wherein each R₂ is independently selected from the group of hydrogen or a C₁-C₈ alkyl;
M is selected from the group of:
i) a C₁-C₂₄ divalent linear or branched alkylene radical;
ii) Z-X-Z, and
iii) --(D-U-Z-X-Z-U)ₘ-D-
wherein:
m is an integer from 1 to about 10;
each Z is independently a substituted or unsubstituted
divalent C₂-C₄₀ alkylene radical;
X is polysiloxane moiety;
U is —C(O)O— or —C(O)NH—; and
each D is independently a C₁-C₂₄ divalent linear or branched alkylene radical;
e) and mixtures thereof.
